(19) United States
(12) Patent Application Publication
(10) Pub. No.: US 2025/0010332 A1
(43) Pub. Date: Jan. 9, 2025

(54) COMPOSITE MATERIAL AND ITS PREPARATION

(71) Applicant: City University of Hong Kong, Kowloon (HK)

(72) Inventors: Yuwei Du, Kowloon (HK); Chi Yan Tso, Kowloon (HK); Sai Liu, Kowloon (HK); Tsz Chung Ho, Kowloon (HK)

(21) Appl. No.: 18/347,319

(22) Filed: Jul. 5, 2023

(51) Int. Cl. B05D 5/06; B05D 7/06; B27K 3/15; C09D 5/26; C09D 5/29; C09D 7/20; C09D 7/41; C09D 7/63; C09D 15/00; C09D 133/12

(52) U.S. Cl. CPC B05D 5/06; B05D 7/06; B27K 3/15; C09D 5/26; C09D 5/29; C09D 7/20; C09D 7/41; C09D 7/63; C09D 15/00; C09D 133/12; C08K 5/19

(57) ABSTRACT

A composite material including an optically transparent substrate; a thermochromic layer such as the one including a halide perovskite-based compound provided on the substrate; and a protective layer provided on the thermochromic layer; wherein the optically transparent substrate includes a wood-based material impregnated with a first polymer. A method for preparing the composite material is also addressed.

### TECHNICAL FIELD

The present invention relates a composite material for example particularly, but not exclusively, a thermochromic composite material comprising a transparent wood material and a halide perovskite-based compound; a method for preparing the composite material.

### BACKGROUND OF THE INVENTION

There has been much interested in the aspect of energy saving since people have recognized the progressively serious energy crises in the world. It is believed that one of the key contributions to the energy crises may be the indoor energy consumption. Researchers have indicated that such an intensive indoor energy consumption may originate from the conventional building design.

Typically, glass is used as the window material owing to its exceptional transparency, which ensures the optical view and aesthetic of buildings. However, conventional glass windows exhibit numerous shortcomings, including high weight, fragility, excessive thermal conductivity and glare, giving rise to unsatisfactory building energy efficiency and thermal environment, as well as high safety risks.

As such, researches have been made on the development of smart window or smart window devices for buildings' energy efficiency and thermal management. Typical smart window technology may rely on glass-based materials, such as coating a glass substrate with a layer of thermochromic perovskite material. Meanwhile, transparent wood has emerged as a potential novel alternative to the glass substrate for smart window technology. However, it is appreciated that each of these materials would have certain drawbacks in practical application.

For transparent wood, typically, its fabrication requires a delignification process which involves the removal of lignin and partial hemicellulose from wood so as to effectively decolorize (bleach) the wood material and to increase the wood cell wall accessibility for further chemical modification (e.g., impregnating refractive index-matching polymers into the wood structure). However, it is believed that such delignification process would generally remove around 30 wt % of wood tissue, and therefore damaging and weakening the wood structure, hindering the large-scale production of TW as well as practical standalone window application.

For thermochromic perovskite materials, it is appreciated that such materials generally require to be applied/deposited onto the window glass, which therefore suffers from inherent mechanical and thermal drawbacks thereof, hindering the thermochromic perovskite materials from wider applicability in building constructions.

An alternative approach would be combining the transparent wood with the thermochromic perovskite materials. Typically, it would require impregnating a mixture of thermochromic component/material and the refractive index-matching polymer(s) into the delignified wood, followed by polymerization to obtain a thermochromic transparent wood. However, it is appreciated that on the one hand the thermochromic perovskite material is susceptible to irreversible degradation upon prolonged high-temperature polymerization, and on the other hand the thermochromic perovskite material would fail to perform reversible thermochromism in such a bulk (polymer) form. Thus, the development of mechanically robust thermochromic composite materials for windows application remains a challenge.

The invention seeks to eliminate or at least to mitigate such shortcomings by providing a new or otherwise improved composite material, in particular, a composite material comprising a transparent wood and thermochromic halide perovskite for window application.

### SUMMARY OF THE INVENTION

In a first aspect of the present invention, there is provided a composite material comprising an optically transparent substrate; a thermochromic layer provided on the substrate; and a protective layer provided on the thermochromic layer; wherein the optically transparent substrate comprises a wood-based material impregnated with a first polymer. Optionally, the thermochromic layer comprises a halide perovskite-based compound having a chemical composition of A, B, and X, with A being one or more of a monovalent organic or metal cation, B being a bivalent metal cation, and X being one or more of a halide.

It is optional that the thermochromic halide perovskite-based compound has a general formula of (CH₃NH₃)₄PbI_{6-x-y}BrₓCl_{y}·2H₂O, with x and y each being 0 or a positive integer, and x+y≤6. In an optional embodiment, the halide perovskite-based compound is (CH₃NH₃)₄PbI₅Br₁·2H₂O.

It is optional that the thermochromic layer has a thickness of about 1.1 μm.

In an optional embodiment, the protective layer comprises a second polymer selected from a group consisting of poly(methyl methacrylate), octadecyltrichorosilane, hexadecyltrimethoxysilane, and a combination thereof. Optionally, the protective layer forms a hydrophobic surface.

It is optional that the wood-based material comprises a plurality of lignin-modified wood fibers that are decolorized, aligned to form an interconnected network structure and being infiltrated with the first polymer. Optionally, the first polymer is selected from a group consisting of epoxy resin, poly(methyl methacrylate), polyvinylpyrrolidone, poly(vinyl alcohol), polydimethylsiloxane, poly(acrylic acid), poly(acrylamide), poly(aniline), poly(ethylene oxide), poly(N-acryloxysuccinimide), poly(N-isopropylacrylamide), poly(N-isopropylmethacrylamide), poly(N-vinylcaprolactam), poly(N-vinylpyrrolidone), poly(methacrylic acid), poly(styrene sulfonic acid), polyurethane, poly(propylene oxide), and a combination thereof.

It is optional that the wood-based material comprises any one of balsa wood, oak, beech, birth, ash and basswood.

In an embodiment of the invention, the wood-based material comprises lignin-modified balsa wood, the first and second polymers are poly(methyl methacrylate) and the halide perovskite-based compound has a general formula of (CH₃NH₃)₄PbI_{6-x-y}BrₓCl_{y}·2H₂O, with x and y each being 0 or a positive integer, and x+y≤6.

In an optional embodiment, the composite material has a luminous transmittance of at least 21% when ambient temperature is at or above a first temperature and at least 78% when ambient temperature is at or below a second temperature. Optionally, the first temperature is at least 52° C. to 53° C. or above. It is optional that the second temperature is about 36° C. to 37° C. or less.

In an optional embodiment, solar modulation ability of the composite material at 50 cycles is maintained at at least 94% of the solar modulation ability at 0 cycle. Optionally, the solar modulation ability is above 21%.

In an optional embodiment, the composite material has an optical haze of about 90% or above. Optionally, the composite material has a tensile strength at about 56 MPa, a flexural strength of about 93 MPa and a thermal conductivity at at least 0.24 W/(m·K).

In a second aspect of the invention, there is provided a composite material comprising an optically transparent substrate; a thermochromic layer provided on the substrate; and a protective layer provided on the thermochromic layer; wherein the optically transparent substrate comprises a wood-based material impregnated with a first polymer; and wherein the wood-based material comprises any one of balsa wood, oak, beech, birth, ash and basswood.

In a third aspect of the present invention, there is provided a method for preparing the composite material in accordance with the first aspect, comprising the steps of:
a) removing chromophores of lignin in a wood material to form a lignin-modified wood-based material;
b) impregnating a pre-polymerized first polymer into the lignin-modified wood-based material;
c) polymerizing the first polymer which is impregnated in the lignin-modified wood-based material;
d) spin-coating a thermochromic layer of halide perovskite-based compound on to the lignin-modified wood-based material obtained in step c); and
e) spin-coating a second polymer onto the thermochromic layer.

Optionally, the lignin-modified wood-based material in step c) is treated by a plasma cleaner. It is optional that the lignin-modified wood-based material in step d) is thermally annealed at about 90° C. It is optional that step e) further comprises the step of e1) thermally annealing the second polymer which is spin-coated on the thermochromic layer.

In an optional embodiment, step a) is UV-assisted bleaching by illuminating the wood material with UV for about 20 mins. In an embodiment of the invention, step a) includes brushing 30 wt % of H₂O₂ oxidant and 10 wt % of NaOH onto the wood material before illuminating the wood material with UV.

In an embodiment of the invention, the first polymer is poly(methyl methacrylate) which is pre-polymerized at 75° C. for 15 min in a hot-water bath with 0.5 wt % of 2,2′-azobis (2-methylpropionitrile) (AIBN) (98%) as initiator.

In an embodiment of the invention, the thermochromic halide perovskite-based compound comprises (CH₃NH₃)₄PbI₅Br₁·2H₂O. It is optional that (CH₃NH₃)₄PbI₅Br₁·2H₂O is formed from a (CH₃NH₃)₄PbI₅Br₁·2H₂O halide hybrid perovskite precursor by dissolving methylammonium iodine (MAI), methylammonium bromide (MABr) and lead iodine (PbI₂) with a molar ratio of 3:1:1 in DMF until it forms a homogeneous and transparent solution.

In an embodiment of the invention, the second polymer is poly(methyl methacrylate) which was dissolved in chlorobenzene (CB) with a ratio of 0.1 g: 1000 μL.

### BRIEF DESCRIPTION OF DRAWINGS

The invention will now be more particularly described, by way of example only, with reference to the accompanying drawings, in which:

FIG. 1 is a schematic diagram illustrating the composite material in accordance with an embodiment of the present invention;

FIG. 2A is a schematic diagram illustrating the fabrication of the composite material in accordance with an embodiment of the present invention;

FIG. 2B is a schematic diagram illustrating the fabrication of PVA-based transparent wood (PVA-based TW) and PVA-based perovskite thermochromic transparent wood (PVA-based PTTW);

FIG. 3A shows the photograph and cross-section SEM images of original wood (OW);

FIG. 3B shows the photograph and cross-section SEM images of lignin-modified wood (LMW);

FIG. 3C shows the photograph and cross-section SEM images of PMMA-based transparent wood (TW);

FIG. 4 shows the roughness profile of PMMA-based TW;

FIG. 5A shows the cross-section SEM image of PMMA-based perovskite thermochromic transparent wood (PMMA-based PTTW);

FIG. 5B shows the cross-section SEM image of perovskite and PMMA coating layers;

FIG. 6A shows the SEM image of the surface morphology of the middle perovskite layer;

FIG. 6B shows the SEM image of the surface morphology of the top PMMA layer;

FIG. 6C shows the surface roughness profile of PMMA-based PTTW;

FIG. 7 shows the XRD patterns of PMMA-based PTTW at the hot and cold states;

FIG. 8 shows the EDX chemical mappings of the PMMA-based PTTW surface;

FIG. 9 shows the photographs of PMMA-based PTTW at the hot and colds states;

FIG. 10A shows the UV-vis-NIR transmittance spectra of PMMA-based TW and PMMA-based PTTW at the hot and cold states, as well as the optical properties (i.e., τₗᵤₘ and Δτₛₒₗ) of PMMA-based PTTW;

FIG. 10B shows the optical properties (τₗᵤₘ and Δτₛₒₗ) of PMMA-based PTTW at different perovskite coating spin speeds;

FIG. 11A shows the UV-vis-NIR transmittance spectra of PVA-based PTTW at hot and cold states, as well as the optical properties (i.e., τₗᵤₘ and Δτₛₒₗ) of PVA-based PTTW;

FIG. 11B shows the UV-vis-NIR transmittance spectra of PVA-based TW (1 mm thick);

FIG. 12A shows the optical haze spectra of PMMA-based PTTW and PMMA-based TW. The inserted photographs illustrate the haze of PMMA-based PTTW;

FIG. 12B shows a photograph illustrating the haze of PVA-based TW upon placing at a position closer to the floor;

FIG. 12C shows a photograph illustrating the haze of PVA-based TW upon placing at a position further away from the floor as compared with FIG. 12B;

FIG. 13 shows the temperature-dependent optical transmittance (at 550 nm) of PTTW during the heating and cooling processes as well as the transmittance derivative showing the hysteresis width;

FIG. 14A shows the tensile stress-strain curves of OW, PMMA-based PTTW, and PMMA;

FIG. 14B shows the flexual stress-strain curves of OW, PMMA-based PTTW, and PMMA;

FIG. 15 is a table summarizing the mechanical properties of OW, PMMA-based PTTW, and PMMA;

FIG. 16A shows the thermal conductivities of OW, PMMA-based PTTW, and PMMA;

FIG. 16B shows the heat capacity curves of OW, PMMA-based PTTW, and PMMA;

FIG. 17 shows the water contact angles of OW, PMMA-based TW, Bare-PTTW (i.e. without the top PMMA coating), and PMMA-based PTTW;

FIG. 18A shows τₗᵤₘ and Δτₛₒₗ of Bare-PTTW (i.e. without the top PMMA coating) at different cycle times;

FIG. 18B shows τₗᵤₘ and Δτₛₒₗ of PMMA-based PTTW at different cycle times;

FIG. 19 is a schematic diagram illustrating the model house structure for model house field test;

FIG. 20 is a photograph showing the experimental setup of the model house field test at City University of Hong Kong rooftop;

FIG. 21A is a photograph showing a large-scale PMMA-based TW for use in the model house field test;

FIG. 21B is a photograph showing a large-scale PMMA-based PTTW for use in the model house field test;

FIG. 22 is an indoor air temperature plots of the model house field test obtained on Oct. 27, 2022 in Hong Kong, along with the real-time solar irradiance and ambient temperature;

FIG. 23 is a table summarizing the meteorological data of model house field test on Oct. 27, 2022;

FIG. 24 is a schematic diagram of the building model used for EnergyPlus simulation and the structure of the four windows for comparison (i.e., Glass, PMMA-based TW, PT-Glass, and PMMA-based PTTW windows);

FIG. 25 is a table summarizing the information of the building model used for EnergyPlus simulation;

FIG. 26 is a table summarizing the optical information of the four windows used for EnergyPlus simulation;

FIG. 27 is a table summarizing the information of 8 ASHARE climate zones and the representative cities;

FIG. 28 shows the energy saving percentages of PMMA-based TW, PT-Glass and PMMA-based PTTW window in 8 climate zones;

FIG. 29 shows the global energy-saving map of PMMA-based PTTW window;

FIG. 30 shows the HVAC energy consumption by sector of the four windows in Hong Kong; and

FIG. 31 shows the monthly energy consumption of the four windows (histograms) and energy savings of PMMA-based TW, PT-Glass, and PMMA-based PTTW windows (lines) in Hong

### DETAILED DESCRIPTION OF OPTIONAL EMBODIMENT

As used herein, the forms “a”, “an”, and “the” are intended to include the singular and plural forms unless the context clearly indicates otherwise.

The words “example” or “exemplary” used in this invention are intended to serve as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion.

Without intending to be limited by theory, the inventors have, through their own research, trials, and experiments, devised a thermochromic composite material. The thermochromic composite material is devised by employing an optically transparent and mechanically robust wood as the substrate, and a thermochromic halide perovskite which functionalizes the wood with smart and passive solar regulation mechanism. In particular, when deployed as smart window, it is found that the thermochromic composite material may perform effective solar-radiation modulation driven by its drastic thermochromism. For example, in cold weather, the thermochromic composite material may remain at the bleached cold state, allowing most of the incident solar radiation to pass through; whereas in hot weather, the thermochromic composite material may transform into the colored hot state when the window surface temperature reaches above its transition temperature, blocking a significant portion of the visible light. As such, it is appreciated that the thermochromic composite material would effectively regulate the indoor temperature and thus contribute to the building thermal management and energy saving.

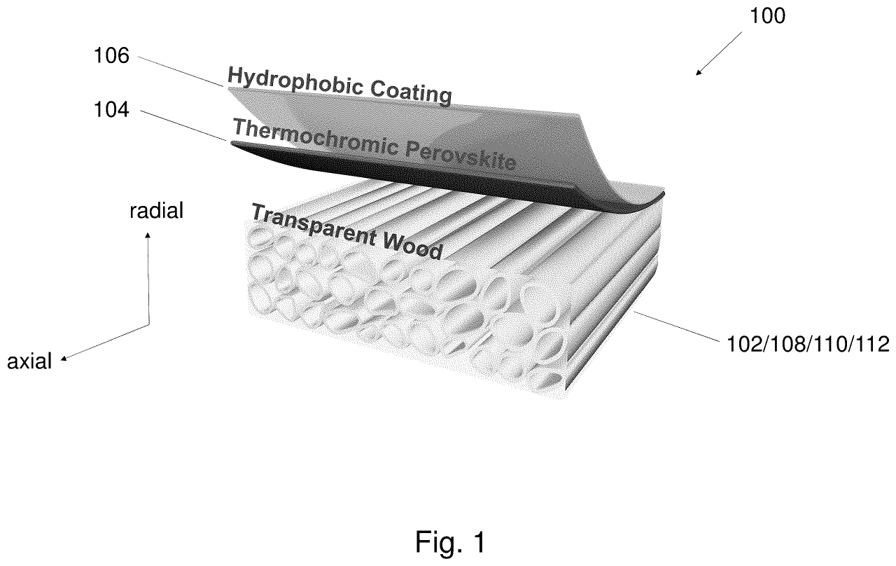

According to the invention, there is provided a composite material, in particular a thermochromic composite material as exemplified in FIG. 1. As shown, the composite material 100 comprises an optically transparent substrate 102, a thermochromic layer 104 provided on the substrate; and a protective layer 106 provided on the thermochromic layer. In particular, the optically transparent substrate may comprise a wood-based material 108 impregnated with a first polymer 110.

The term “wood-based material” as used herein means that the material originates from a wood material such as a natural wood material and is particularly with its wood structure chemically modified. Referring to FIG. 1, the wood-based material includes a plurality of wood fibers 112 to form an interconnected network structure. The wood fibers are particularly a plurality of lignin-modified wood fibers. The phrase “lignin-modified” denotes that the (natural) wood material has been subjected to a wood structure modification process and after which the lignin chromophores of the wood material are deactivated (i.e., decolorized) with the wood tissue substantially remained. It shall be noted that such phrase is intended to distinguish from the term/phrase “delignification”/“delignified” and the like, which involves the removal (i.e., substantial loss) of wood tissue such as by about 30 wt %, after the chemical treatment.

Turning back to FIG. 1, the plurality of lignin-modified wood fibers 112 are aligned in an axial direction to form the interconnected network structure. The interconnected network structure is infiltrated with the first polymer 110. Preferably, the first polymer may have a refractive index that matches with that of the wood-based material and therefore enhancing the optically transparency of the wood-based material.

It is appreciated that any polymers having a refractive index that matches with the wood-based material may be used as the first polymer. In an embodiment where the wood-based material has a refractive index of about 1.5 to about 1.55, the first polymer may be selected from the group consisting of epoxy resin, poly(methyl methacrylate), polyvinylpyrrolidone, poly(vinyl alcohol), polydimethylsiloxane, poly(acrylic acid), poly(acrylamide), poly(aniline), poly(ethylene oxide), poly(N-acryloxysuccinimide), poly(N-isopropylacrylamide), poly(N-isopropylmethacrylamide), poly(N-vinylcaprolactam), poly(N-vinylpyrrolidone), poly(methacrylic acid), poly(styrene sulfonic acid), polyurethane, poly(propylene oxide), and a combination thereof.

The wood-based material 108 may comprise any one of balsa wood, oak, beech, birth, ash and basswood. It is appreciated that different wood types may result in different optical properties such as optical transparency and haze after lignin modification as described above, and may result in different mechanical properties. A person skilled in the art may choose a particular wood types to enable the present invention according to their practical needs. As a specific embodiment, the wood-based material may comprise balsa wood, in particular, lignin-modified balsa wood.

In an embodiment, the wood-based material may have a thickness of about 0.75 mm to about 1.2 mm, which may be about 30% thinner than the original wood material. It is believed that although there is no substantial loss of wood tissue in the lignin-modified wood fibers, with the infiltration of the first polymer, such as by way of polymerization, it would lead to self-densification of the wood-first polymer composite during such polymerization process, and therefore resulting in a decrease of thickness of the wood-based material as compared with the (original) wood material.

The thermochromic layer 104 may comprise a halide perovskite-based compound having a chemical composition of A, B, and, X, with A being one or more of a monovalent organic or metal cation, B being a bivalent metal cation, and X being one or more of a halide. The term “halide perovskite-based compound” as used herein denotes the perovskite compounds having the general chemical formula of ABX₃ or the perovskite-related compounds having phrases converted from the ABX₃ lattice, such as those having a general chemical formula of A₂BX₄, ABX₄, A₃B₂X₉, A₂B′B″X₆ or A₂BX₆, and A₄BX₆. In an embodiment, the halide perovskite-based compound may have a general formula of AₙBXₘ, with n and m each being an atomic ratio, where n is 1, 2 or 4 and m is 3, 4 or 6. For example, the halide perovskite-based compound may have a general formula of ABX₃, A₂BX₆, A₂BX₄, A₄BX₆, etc. The monovalent organic or metal cation A may be selected from any one of CH₃NH₃⁺, CH(NH₂)₂⁺ and Cs⁺, the bivalent metal cation B may be selected from any one of Pb₂⁺ and Sn₂⁺, and the halide X bivalent metal cation selected from any one of I⁻, Br⁻, Cl⁻ or a combination thereof.

In a particular embodiment, the halide perovskite-based compound may be the one with thermochromic function, and may take the dihydrated form under ambient conditions. Preferably, the halide perovskite-based compound may have a general formula of (CH₃NH₃)₄PbI_{6-x-y}BrₓCl_{y}·2H₂O, with x and y each being 0 or a positive integer, and x+y≤6. As a specific embodiment, the halide perovskite-based compound may be (CH₃NH₃)₄PbI₅Br₁·2H₂O.

The thermochromic layer may have a thickness of about 0.8 μm to about 1.2 μm. The inventors have devised that the thickness of the thermochromic layer may substantially affect the optical properties of the composite material (e.g. luminous transmittance and solar modulation ability) based on Beer-Lambert's Law. Detailed discussion will be disclosed in the later part of the present disclosure. In a specific embodiment, the thermochromic layer may have a thickness of about 1.1 μm.

Furthermore, it is devised that the thermochromic layer may be provided on the substrate 102 in a direct or indirect manner, depending on the chemical and/or physical nature of the first polymer. For example, in an embodiment where the first polymer is poly(methyl methacrylate) (PMMA), which is believed to be capable of providing a sufficiently smooth and hydrophobic surface for which the thermochromic layer to be deposited thereon, the thermochromic layer 104 may be deposited directly on the substrate 102 (i.e., the thermochromic layer may be in direct contact with the substrate). In an optional or additional embodiment where the first polymer may be poly(vinyl alcohol) (PVA), which is believed to provide a relatively less smooth and hydrophobic surface as compared with PMMA, the thermochromic layer may be indirectly deposited onto the substrate via a buffer layer (not shown) in between. That said, the composite material may comprise a buffer layer such as a layer of SiO₂ that is sandwiched between the substrate 102 and the thermochromic layer 104.

The protective layer 106 may be a coating or a layer that forms a hydrophobic surface on the thermochromic layer. That said, the protective layer 106 may be a hydrophobic coating or a hydrophobic layer. It is appreciated that the hygroscopic nature of perovskite materials renders them vulnerable to moisture-induced degradation and therefore unstable performance over long-term usage. With the use of the protective layer 106, it is believed that the layer 106 would enhance the water/moisture repellency of the thermochromic layer 104 and therefore enhancing the durability as well as performance stability of the composite material 100. In an example embodiment, the composite material having the protective layer may have the solar modulation ability at 50 cycles being maintained at at least 94% of the solar modulation ability at 0 cycle, which may be above 21%.

The protective layer may comprise a second polymer selected from a group consisting of poly(methyl methacrylate), octadecyltrichorosilane, hexadecyltrimethoxysilane, and a combination thereof. Optionally, the second polymer may be identical to the first polymer so as to minimize the refractive index differences between the first and the second polymers, which in turn maximizing the optical transparency of the composite material. In a specific embodiment, the second polymer may be poly(methyl methacrylate).

As mentioned above, the composite material of the present invention is particularly suitable for smart window applications. In particular, it is found that the composite material of the present invention may at least possess the following properties that are preferable for such applications.

For example, the composite material of the present invention is thermochromic. That said, the composite material 100 may arrange to change its optical transparency/luminous transmittance and/or color in response to the change of external temperature. In an embodiment where the thermochromic layer of the composite material comprises the halide perovskite-based compound as described herein, the composite material may have a luminous transmittance of at least 21% when ambient temperature is at or above a first temperature, such as at least 52° C. to 53° C. or above, and at least 78% when ambient temperature is at or below a second temperature, such as about 36° C. to 37° C. or less. In particular, it is found that the above thermochromic transition may be completed reversibly by about 102 seconds on average, which is believed to be preferable in practical window applications.

In addition, in an embodiment, the composite material of the present invention may have an optical haze of about 90% or above, which is believed to be preferable for window applications, in particular when considering privacy purposes.

Furthermore, in an embodiment, it is found that the composite material may have a tensile strength at about 56 MPa, a flexural strength of about 93 MPa and a thermal conductivity at at least 0.24 W/(m·K). It is believed that the high toughness and stiffness of the composite material may help mitigating the safety risks of (glass) windows; while the low thermal conductivity (as compared with glass (1.0 W/(m·K))) may help reduce the heat loss/gain through windows and thus saving the energy used by air conditioning.

Detailed discussion on the properties and performance of the composition material will be disclosed in the later part of the present disclosure.

The method for preparing the composite material as described herein is now disclosed. The method may comprises the steps of:
a) removing chromophores of lignin in a wood material to form a lignin-modified wood-based material;
b) impregnating a prepolymerized first polymer into the lignin-modified wood-based material;
c) polymerizing the first polymer which is impregnated in the lignin-modified wood-based material;
d) spin-coating a thermochromic layer of halide perovskite-based compound on to the lignin-modified wood-based material obtained in step c); and
e) spin-coating a second polymer onto the thermochromic layer.

In particular, the removal of lignin chromophore may involve a chemical treatment process which employs hydroxyl radicals for oxidation reaction. The hydroxyl radicals may be generated from a source such as ozone, hydrogen peroxide and optionally under UV light. In an embodiment, step a) may be UV-assisted bleaching by illuminating the wood material as described herein with UV for about 20 mins. In particular, the wood material may be applied thereon with 30 wt % of H₂O₂ oxidant and 10 wt % of NaOH, such as by way of brushing the wood material with a solution mixture of H₂O₂/NaOH as mentioned above, before the illumination. The AOP process may be repeated for, such as 10 times, until the lignin is completely decolorized. As mentioned, it is believed that by using the above lignin modification/decolorization process instead of the delignification process, the processed wood material may have less loss of wood tissue and therefore resulting in a better mechanical property.

The impregnation of the pre-polymerized first polymer in step b) may be performed under vacuum assistance and may be performed for, e.g. 24 hours. It is preferred that the first polymer is in pre-polymerized form upon the impregnation as it is believed that the pre-polymerized first polymer would have sufficient viscosity to thoroughly infiltrate in the wood cells and to retain therein for the subsequent polymerization process (i.e., step c)). In an embodiment where the first polymer is poly(methyl methacrylate) (PMMA), the pre-polymerized PMMA may be prepared by pre-polymerizing pure methyl methacrylate (MMA) monomer at 75° C. for 15 min in a hot-water bath with 0.5 wt % of 2,2′-azobis (2-methylpropionitrile) (AIBN) (98%) as initiator. Optionally or additionally, the pre-polymerized PMMA may be cooled down to room temperature, such as by an ice-water bath, for the impregnation as described above.

In step c), the polymerization of the (impregnated) first polymer may be performed under a temperature of, e.g., about 70° C. in an oven for, e.g., 4 hours. It is appreciated that after step c), a lignin-modified wood-based material impregnated with the first polymer will be obtained.

While the impregnated first polymer may enhance the hydrophobicity and/or smoothness of the (original) wood material, it is believed that such an enhanced hydrophobicity and/or smoothness may not be sufficient to support an optimal coating of the thermochromic layer in step d). Thus, before commencing step d), it is preferred to change the surface wettability of the lignin-modified wood-based material. In an example embodiment, the lignin-modified wood-based material in step c) may be treated by a plasma cleaner to change the surface wettability of the lignin-modified wood-based material. Optionally or additionally, a buffer layer of, for example, SiO₂ may be provided on the plasma-treated lignin-modified wood-based material to further enhance the hydrophobicity and/or smoothness of the lignin-modified wood-based material. In an optional embodiment, the buffer layer of SiO₂ may be provided on the plasma-treated lignin-modified wood-based material by way of spin-coating, such as with a rpm of about 2000 for about 30 seconds. It is also optional that, in this embodiment, the lignin-modified wood-based material containing the SiO₂ buffer layer may be further treated by the plasma cleaner prior to commencing step d).

In step d), the thermochromic layer may be formed by spin-coating a solution of the halide perovskite-based compound onto the plasma-treated lignin-modified wood-based material. For example, in an embodiment where the halide perovskite-based compound is (CH₃NH₃)₄PbI₅Br₁·2H₂O, the solution may be prepared by forming a (CH₃NH₃)₄PbI₅Br₁·2H₂O halide hybrid perovskite precursor by dissolving methylammonium iodine (MAI), methylammonium bromide (MABr) and lead iodine (PbI₂) with a molar ratio of 3:1:1 in N,N-dimethylformamide (DMF) until it forms a homogeneous and transparent solution. The as-prepared precursor solution may then be spin-coated onto the plasma-treated lignin-modified wood-based material at a rotation speed of, such as about 2000 rpm for about 30 seconds. After the spin-coating in step d), the lignin-modified wood-based material with the thermochromic layer thereon may be thermally annealed at a temperature of about 90° C. for about 10 mins.

After step d), a second polymer may be spin-coated onto the thermochromic layer to form a protective layer as described herein. In particular, the second polymer may be prepared in form of a solution which is then spin-coated on the thermochromic layer. For example, in an embodiment where the second polymer is poly(methyl methacrylate) (PMMA), the PMMA solution may be prepared by dissolving PMMA powder in chlorobenzene (CB) with a ratio of 0.1 g: 1000 μL, which may then be spin-coated on the thermochromic layer at a rotation speed of about 1000 rpm for about 30 seconds. After that, the method may proceed to step e1) which includes thermally annealing the spin-coated second polymer such as PMMA at a temperature of about 90° C. for about 10 mins.

Hereinafter, the present invention is described more specifically by way of examples, but the present invention is not limited thereto.

### EXAMPLES

### Methods and Characterization

### Characterization of PMMA-Based PTTW

Luminous transmittance, τₗᵤₘ, and the solar modulation ability, Δτₛₒₗ of PMMA-based PTTW were characterized by an UV-VIS-NIR spectrophotometer with an integrating sphere (1050+, PerkinElmer Lambda). The integral luminous transmittance, τₗᵤₘ (380-780 nm) is calculated by

$${τ}_{lum} = \frac{{\int }_{λ = 380 nm}^{780 nm} \overline{y} ( λ ) τ ( λ ) d λ}{{\int }_{λ = 380 nm}^{780 nm} \overline{y} ( λ ) d λ} ,$$

where (λ) is the transmittance at wavelength λ, y̅(λ) is the CIE (International Commission on Illumination) standards for the photonic luminous efficiency of the human eye. Then, the average luminous transmittance can be calculated by

$${\overline{τ}}_{lum , ave} = \frac{{τ}_{lum , cold} + {τ}_{lum , hot}}{2} ,$$

where τₗᵤₘ, cold and τₗᵤₘ, hot are the luminous transmittance at the cold and hot states, respectively. Similarly, the solar transmittance, τₛₒₗ (250-2500 nm) can be calculated by

$${τ}_{sol} = \frac{{\int }_{λ = 250 nm}^{2500 nm} {AM}_{1.5} ( λ ) T ( λ ) d λ}{{\int }_{λ = 250 nm}^{2500 nm} {AM}_{1.5} ( λ ) d λ} ,$$

where AM_{1.5}(λ) is the solar irradiance spectrum for an absolute air mass of 1.5. Hence, the solar modulation ability, Δτₛₒₗ can be determined by Δτₛₒₗ=τ_{sol,cold}−τ_{sol,hot}, where τ_{sol,cold} and τ_{sol,hot} are the solar transmittance at the cold and hot states, respectively.

The optical haze was calculated based on ASTM D1003 “Standard Method for Haze and Luminous Transmittance of Transparent Plastics”, which can be defined as

$$Haze = ( \frac{{T}_{4}}{{T}_{2}} - \frac{{T}_{3}}{{T}_{1}} ) \times 100 \% ,$$

where T₁ is the total incident visible light, T₂ is the visible light transmittance of the sample, T₃ is the light scattering of the equipment, and T₄ is the light scattering of the sample and equipment.

The transition temperature Tₜᵣₐₙₛ of PMMA-based PTTW is regarded as the temperature showing the maximum first derivative of its visible transmittance with the change of temperature, as calculated by

$${T}_{trans} = max \vert \frac{dy}{dx} \vert ,$$

where y denotes the visible light transmittance and x denotes the temperature. The visible light transmittance with the temperature change during the heating and cooling process was measured by a Lens Transmittance meter (SDR8508, SpeeDre) with a temperature interval of 2° C. Thus, the average transition temperature T̅ₜᵣₐₙₛ is calculated by

$${\overline{T}}_{trans} = \frac{{T}_{trans , heating} + {T}_{trans , cooling}}{2} ,$$

where T_{trans,heating} and T_{trans,cooling} are the transition temperatures for the heating and cooling processes, respectively.

The hysteresis width ΔTₜᵣₐₙₛ, which is defined as the difference between the heating and cooling process transition temperatures, can be calculated by

$$Δ {T}_{trans} = \vert {T}_{trans , heating} - {T}_{trans , cooling} \vert .$$

For transition time tₜᵣₐₙₛ measurement, the heating transition time t_{trans,heating} was measured by heating PMMA-based PTTW at its heating transition temperature, and the time required to observe the complete color change was regarded as t_{trans,heating}. For the cooling transition temperature t_{trans,cooling}, the heated PMMA-based PTTW was naturally cooled to room temperature and the time used to totally fade back to colorless was recorded as t_{trans,cooling}. The average transition time t̅ₜᵣₐₙₛ can thus be calculated by

$${\overline{t}}_{trans} = \frac{{t}_{trans , heating} + {t}_{trans , cooling}}{2} .$$

For comparison, a PVA-based PTTW (poly(vinyl alcohol)-based perovskite thermochromic transparent wood) is fabricated and characterized in the same way as the PMMA-based PTTW. Fabrication details of PVA-based PTTW will be disclosed in Example 1.

The cross-section and cellular structure of the original wood (OW), lignin-modified wood (LMW), PMMA-based transparent wood (TW), and PMMA-based PTTW as well as the perovskite surface morphology and the corresponding Energy Dispersive X-ray spectroscopy (EDX) elemental mappings were observed by a field emission scanning electron microscope (Quanta 450, FEI). The FTIR spectra of OW, LMW and PMMA-based TW were obtained by a Fourier-transform infrared (FTIR) spectrometer (IRAffinity-1S, SHIMAZU). The perovskite crystalline structure of PMMA-based PTTW at the hot and cold states were identified by an X-ray diffractometer (Panalytical). The water surface contact angle was captured by a drop shape analyzer (DSA25, Kruss). The surface roughness was measured by a surface profiler (XP-2, Ambios).

The mechanical proprieties were analyzed by a universal material testing system (3382 Series UTM System, Instron). The tensile and bending tests were conducted based on ASTM D638 Standard Test Method for Tensile Properties of Plastics and ASTM D790 Standard Test Methods for Flexural Properties of Unreinforced and Reinforced Plastics and Electrical Insulating Materials, respectively. The thermal conductivity was measured by a thermal conductivity analyzer (TCi, C-Therm), and the heat capacity was measured by a Differential Scanning calorimeter (DSC) (Q1000, TA).

### Model-House Field Test

The outdoor model-house field test was conducted at and open area on the rooftop garden of City University of Hong Kong without sunlight blocking. Four identical model houses with a dimension of 20×20×20 cm³ were used to be installed with the four investigating windows. The model houses were made of acrylic and thermal-insulating styrofoam, and wrapped with solar-reflecting aluminum foil to minimize the heat transfer through the model-house walls. The windows were installed in a double-glazing window frame located on the top of the model houses facing towards the sky. The four model houses were placed next to each other to ensure the same amount of solar radiation, but left with ample space to prevent heat exchange between the model houses. T-type thermocouples (RS PRO) were calibrated and placed at the center of the model houses to record the indoor air temperature (YG-BX, Wuhan YIGU Chenyun Technology Co., Ltd). A weather station was put close to the model houses to monitor the outdoor weather data.

### Energy-Saving Simulation

The energy saving simulation was implemented by Energyplus_9.2.0 software, in which two IDF files were required-one is the simulated building model, the other one is the weather data file. For the building model, a 10-floor high-rise apartment reference building model developed by the U.S. Department of Energy (DOE) was employed, with 30% window-to-wall ratio for all the four façades, ensuring sufficient impact of window heat transfer on the building energy consumption. To simulate the building energy performance with different windows, the window optical and thermal properties (i.e., U-values, solar heat gain coefficients, shading coefficients, and visible transmittances) were input to EnergyPlus, which were calculated using WINDOW program developed by Lawrence Berkeley National Laboratory (LBNL), in which the windows were assembled in the double-glazing structure, and the optical and thermal properties of the glazing materials were measured experimentally. Regarding weather data, all the weather data files were downloaded from the official website of the EnergyPlus to ensure the weather-data accuracy and reliability.

### Example 1

### Fabrication of PMMA-Based PTTW

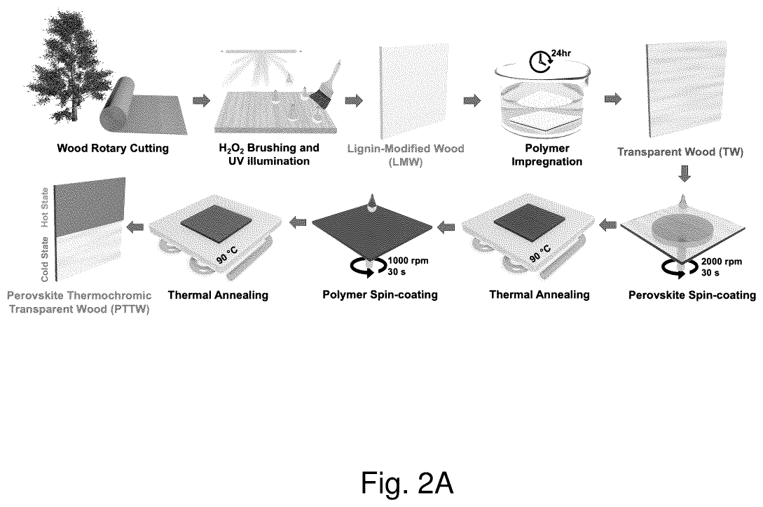

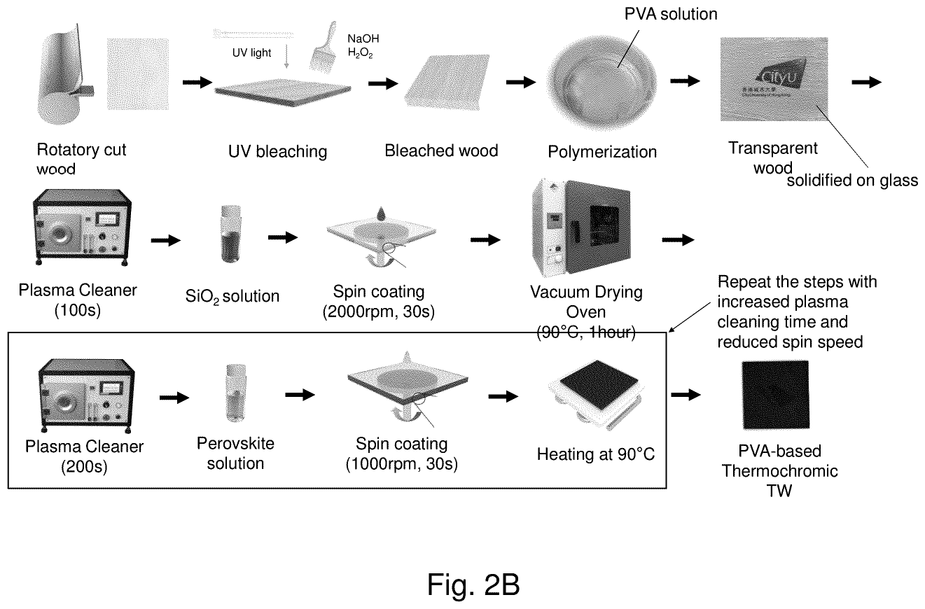

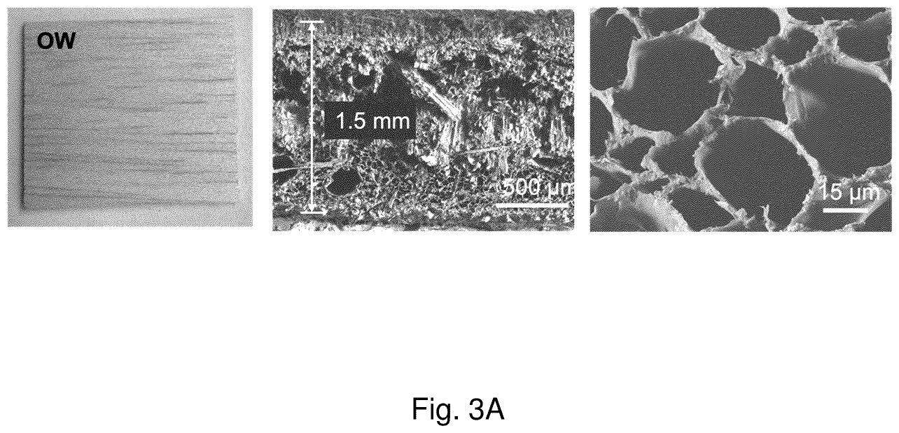

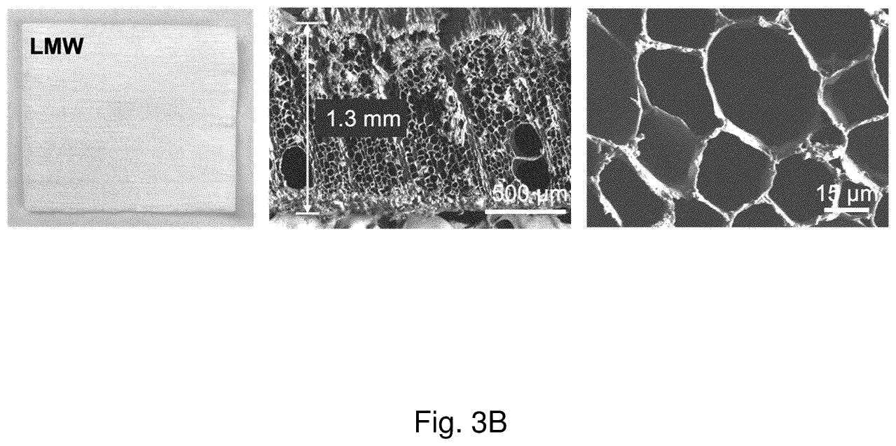

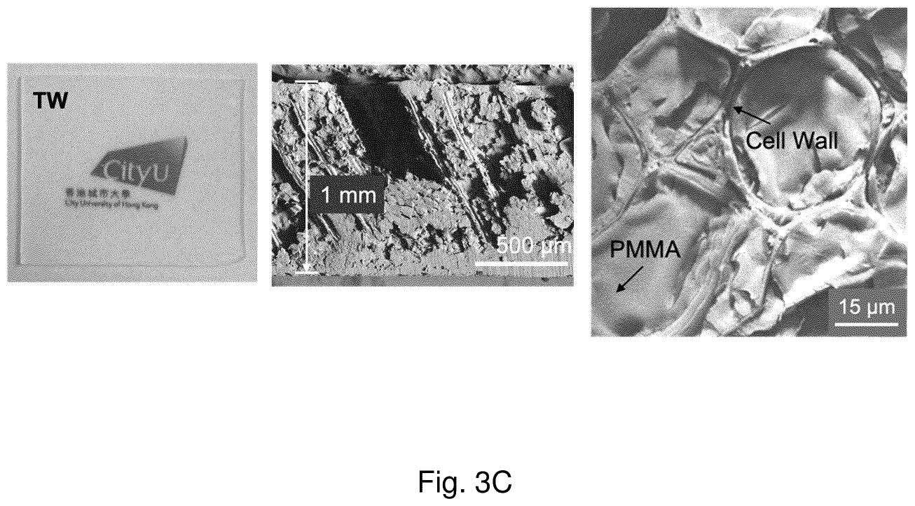

The synthetic scheme of the PMMA-based PTTW is illustrated in FIG. 2A. Specifically, rotary cut thin balsa wood slices (10×10×1.5 mm) (FIG. 3A) were brushed with H₂O₂ oxidant (AQA, 30%) and NaOH (Honeywell Fluka, 10%), and then illuminated by a UV lamp for 20 min. This process was repeated for about 10 times until the wood slices became completely white, indicating the sufficient deactivation of lignin chromophores. The lignin-modified wood (LMW) slices (FIG. 3B) were then washed by DI water, ethanol, and acetone sequentially to remove the residual chemicals. After that, pure methyl methacrylate (MMA) monomer (Aladdin, 99%) was pre-polymerized at 75° C. for 15 min in a hot-water bath with 0.5 wt % of 2,2′-Azobis (2methylpropionitrile) (AIBN) (Aladdin, 98%) as initiator. The pre-polymerized MMA was then cooled down in an ice-water bath to room temperature for use in the subsequent infiltration process.

The pre-polymerized MMA was infiltrated into the lignin-modified wood slices with vacuum assistance for 24 hr, and the MMA-impregnated wood was then fully polymerized in the oven at 70° C. for 4 hours to achieve PMMA-based transparent wood (TW) (FIG. 3C) for use as the substrate for the following thermochromic perovskite deposition.

MA₄PbI₅Br₁·2H₂O halide hybrid perovskite precursor (MA=methylammonium, CH₃NH₃⁺) was synthesized in a glovebox by dissolving methylammonium iodine (MAI), methylammonium bromide (MABr) and lead iodine (PbI₂) (Xi'an Polymer Light Technology Corp.) with a molar ratio of 3:1:1 and in DMF solvent (N,N′-dimethylformamide) and then stirring at 50° C. for 3 h until the solution was clear. After that, the fabricated transparent wood was treated by the plasma cleaner to change the surface wettability of the intrinsically hydrophobic PMMA-based transparent wood. Then the perovskite precursor was spin-coated on the plasma-treated transparent wood substrate at 2000 rpm for 30 s, followed by thermal annealing at 90° C. for 10 min.

Poly(methyl methacrylate) (PMMA) powder (Mitsubishi Chemical America) was dissolved in Chlorobenzene (CB) with a ratio of 0.1 g: 1000 μL and stirred 50° C. for about 1 hr until the solution turned transparent. The prepared PMMA solution was then spin-coated on the perovskite-deposited transparent wood at 1000 rpm for 30 s, followed by thermal annealing at 90° C. for 10 mins. Herein, PMMA-based perovskite thermochromic transparent wood (PMMA-based PTTW) is fabricated.

For comparison, a PVA-based PTTW (poly(vinyl alcohol)-based perovskite thermochromic transparent wood) with 1 mm thickness is fabricated. As illustrated in FIG. 2B, the fabrication generally involves spin-coating a halide hybrid perovskite precursor onto a PVA-based TW substrate. Briefly, the method of preparing PVA-based PTTW commences with the step of preparing the PVA-based TW by way of UV-assisted bleaching and polymer infiltration, which is similar to that of PMMA-based TW except that PVA is used instead of PMMA. After obtaining the PVA-based TW and subjecting the same with plasma cleaning, a layer of SiO₂ is spin-coated on the plasma-treated PVA-based TW so as to further enhance hydrophobicity and smoothness of PVA-based TW for optimal perovskite coating. After that, it undergoes substantially similar perovskite spin-coating processes as the PMMA-based PTTW.

### Example 2

### Structural Properties of PMMA-Based PTTW

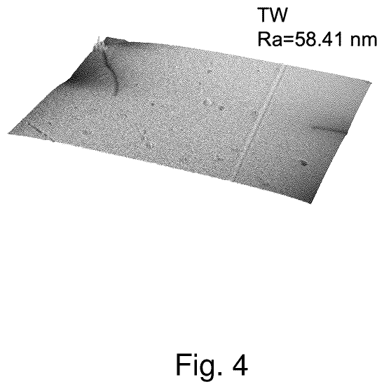

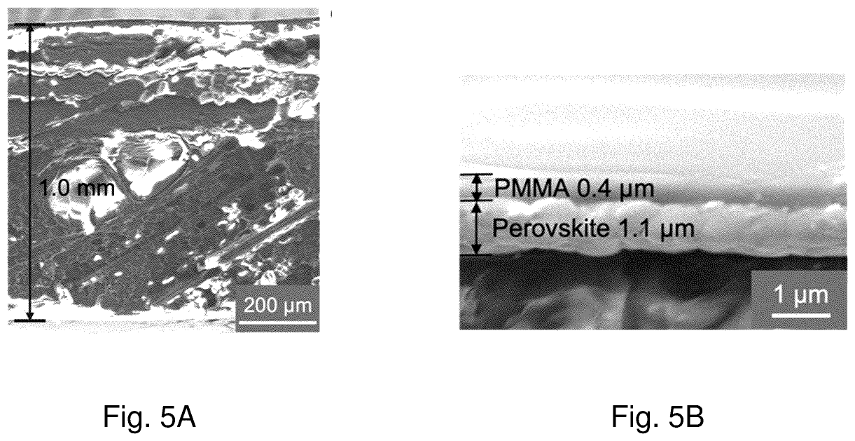

Upon the lignin modification and polymer impregnation process, the resulted TW substrate is optically clear and mechanically robust which is attributed to the thorough infiltration of PMMA polymer into the wood cells and the strong bonding between the polymer and wood cell walls (FIG. 3C, right). Besides, the TW surface is sufficiently covered with PMMA, which provides a neat and smooth surface for perovskite deposition, with low surface roughness Ra of 58.41 nm (FIG. 4). After perovskite deposition and PMMA coating, the as-formed PMMA-based PTTW has a total thickness of about 1 mm (FIG. 5A), which is about 30% thinner than OW with the original thickness of 1.5 mm, resulted from the self-densification of wood-PMMA composite during the polymerization process.

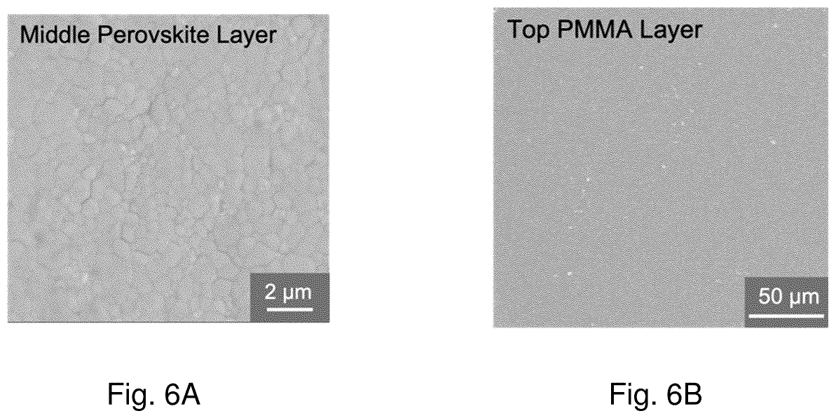

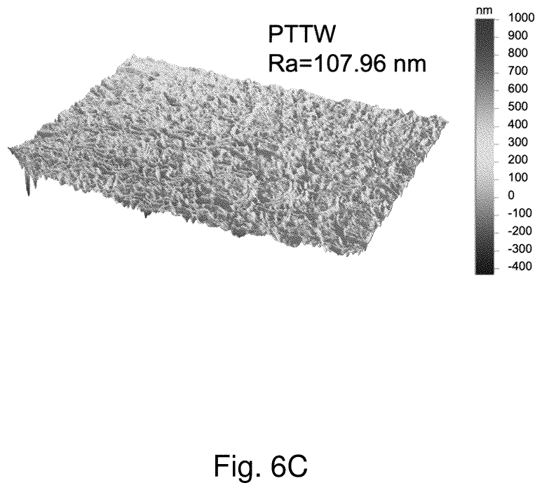

The perovskite and PMMA coated on the TW top surface form as two compact and homogeneous layers with thickness of about 1.1 μm and 0.4 μm, respectively (FIG. 5B). The middle perovskite layer features a dense and uniform surface morphology (FIG. 6A) which is crucial for performing even/uniform thermochromism. The top PMMA layer (FIG. 6B) shows a relatively shinny and smooth surface with Ra of 107.96 nm (FIG. 6C) which is favorable for the surface protection.

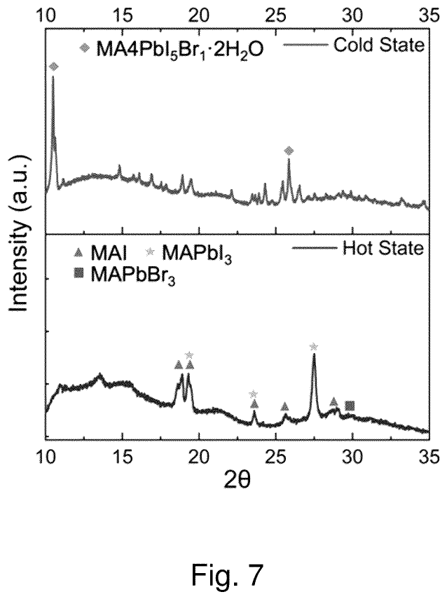

X-ray diffraction (XRD) analysis was conducted to analyze the perovskite crystalline structure of PMMA-based PTTW. As shown in FIG. 7, the XRD patterns of the hot and cold-state PMMA-based PTTW thin-film samples are observed in the 20 range between 10° and 30°. At the cold state, diffraction peaks associated with dihydrated perovskite at about 20=12° and 26° were observed, indicating that PMMA-based PTTW is at the dehydrated MA₄PbI₅Br₁·2H₂O perovskite phase at the cold state.

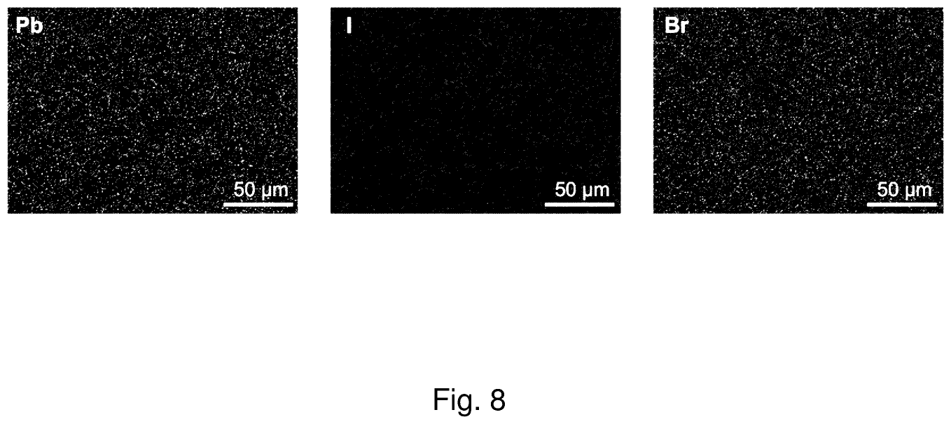

By comparison, disparate XRD patterns of PMMA-based PTTW were displayed at the hot state with characteristic peaks of MAPbI₃ and MAPbBr₃ as well as MAI, manifesting the phase transformation to the cubic perovskite phase due to the debonding of the crystal water. Besides, the Energy Dispersive X-ray spectroscopy (EDX) chemical mappings prove that the perovskite elements (i.e., Pb, I and Br) are well distributed on the PMMA-based PTTW surface (FIG. 8).

### Example 3

### Thermochromic Properties of PMMA-Based PTTW

It is believed that optical properties (i.e. luminous transmittance τₗᵤₘ and solar modulation ability Δτₛₒₗ) are vital for the thermal-regulation and energy-saving performance of smart windows. Thus, the thermochromic properties of PMMA-based PTTW were investigated.

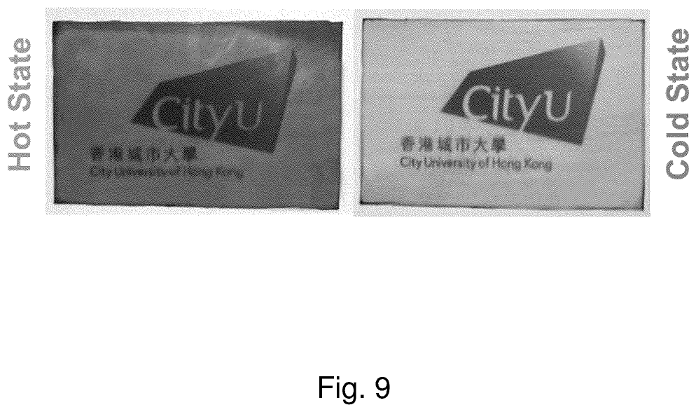

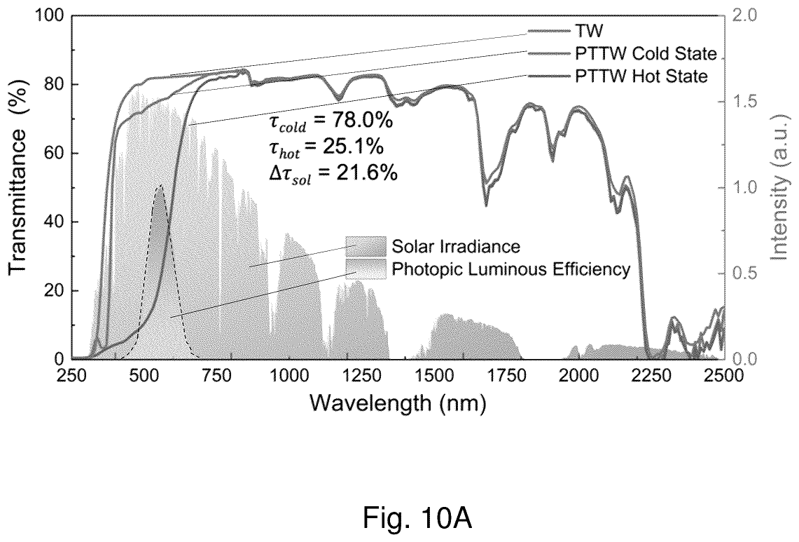

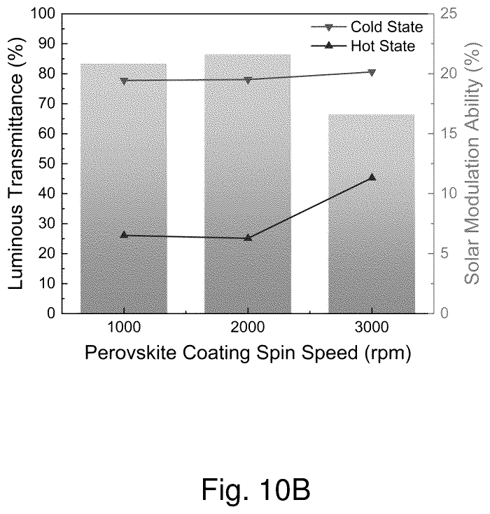

The fabricated PMMA-based PTTW is featured by its significant thermochromism with distinct color variance-reddish brown at the hot state and colorless at the cold state (FIG. 9). To quantify the optical properties of PMMA-based PTTW, UV-vis-NIR transmittance spectra of the hot- and cold-state PMMA-based PTTW were obtained (FIG. 10A), where a drastic difference in visible light transmittance (380-780 nm) between the hot- and cold-state is prominent due to the visible-range thermochromic characteristic of MA₄PbI₅Br₁·2H₂O halide hybrid perovskite. The UV (250-380 nm) and infrared transmittance (780-2500 nm) of the two states are almost coincident.

At the cold state, PMMA-based PTTW is almost bleached and transparent with only a subtle brown tint, so that the corresponding luminous transmittance τ_{lum,cold} is fairly high at 78.0%, and it is comparable to the PMMA-based TW (i.e., about 80%). When PMMA-based PTTW is heated to the hot state, it is stained with reddish brown color and thus significant visible-light absorption is induced, resulting in the notable reduction in luminous transmittance τₗᵤₘ,hot to 25.1%. Because of this significant variation in solar transmittance between the cold state and hot state in the visible light region which accounts for about half of the total solar spectrum, PMMA-based PTTW demonstrates remarkable solar modulation ability Δτₛₒₗ of 21.6%, which is comparable to the results of glass-deposited MA₄PbI₅Br₁·2H₂O halide hybrid perovskite (i.e., 22.1%).

Furthermore, it is found that the optical properties of PMMA-based PTTW can be tuned by modifying the spin speed of the perovskite coating which affects the coating thickness and subsequently alters the optical properties based on Beer-Lambert's law. The τₗᵤₘ and Δτₛₒₗ of PMMA-based PTTW at different perovskite coating spin speeds are displayed in FIG. 10B.

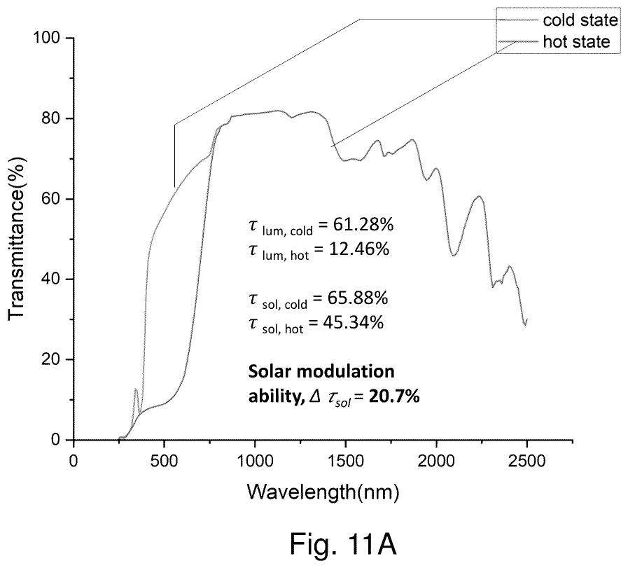

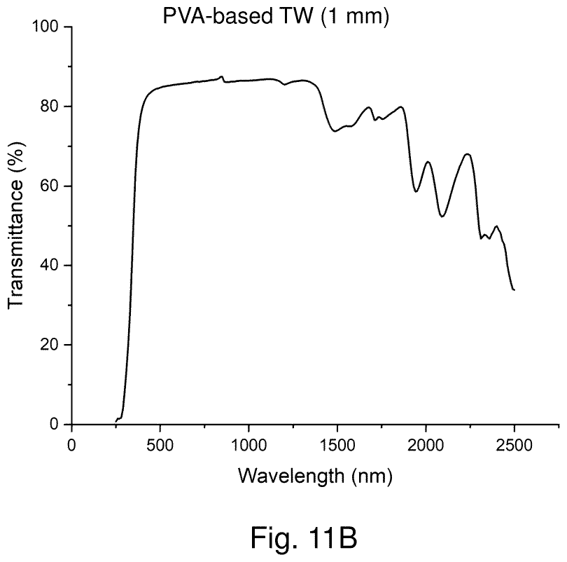

The optical properties of the PVA-based PTTW is also investigated. As shown in FIG. 11A, a fairly drastic difference in visible light transmittance (380-780 nm) between the hot- and cold-state is observed, which is believed to be accounted for by the visible-range thermochromic characteristic of MA₄PbI₅Br₁·2H₂O halide hybrid perovskite; whereas the UV (250-380 nm) and infrared transmittance (780-2500 nm) of the two states are almost coincident.

At the cold state, the PVA-based PTTW has a luminous transmittance τ_{lum,cold} of about 61.28%, which is fairly lower than that of the PVA-based TW (i.e., about 81%) (FIG. 11B). When PVA-based PTTW is heated to the hot state, significant visible-light absorption is induced, resulting in the notable reduction in luminous transmittance τₗᵤₘ, hot to 12.46%. The PVA-based PTTW has a τₛₒₗ, cold of about 65.88% and a τₛₒₗ, hot of about 45.34%. The PVA-based PTTW therefore has a solar modulation ability Δτₛₒₗ of 20.7%, which is slightly lower than that of the PMMA-based PTTW (i.e., 21.6%).

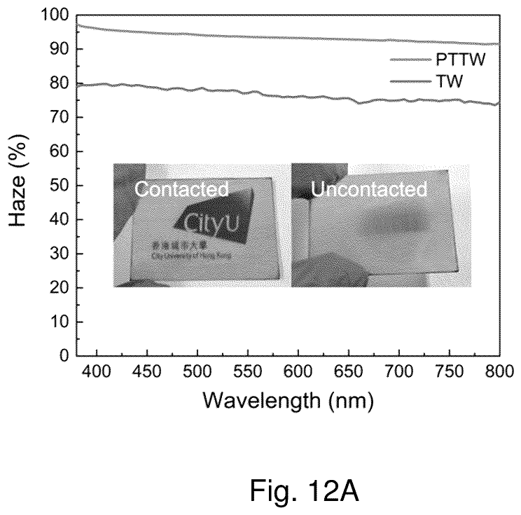

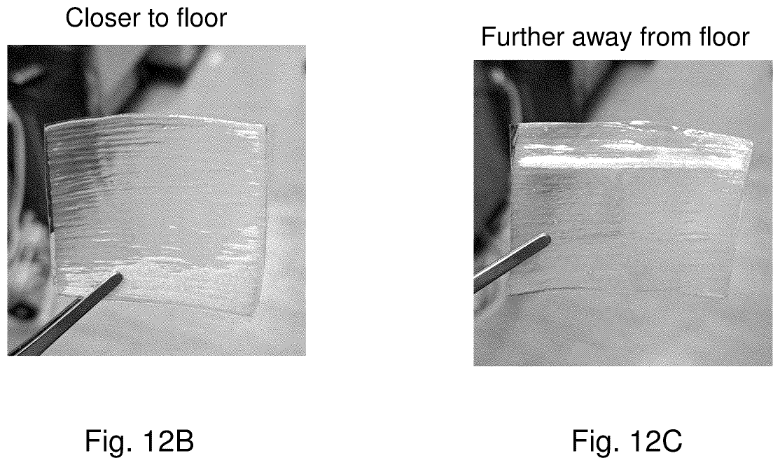

Besides transmittance, optical haze represents another important optical property of smart-windows, which can be defined as the ratio of the scattered light to total transmitted light. The haze spectra presented in FIG. 12A indicate that PMMA-based PTTW possesses an exceptional level of optical haze of approximately 93% within the visible light due to the inherently high-haze characteristic of the underlying TW substrate (i.e., haze ˜80%), which is further substantiated by the inserted figures in FIG. 12A. As shown, the patterns beneath PMMA-based PTTW is clear when contacted but blurred when moved away. The high optical haze of PMMA-based PTTW is beneficial for the light scattering, thereby enhancing privacy and creating a more subdued indoor lighting environment.

The average optical haze of the PVA-based TW samples is found to be about 73.33%. Indeed, as demonstrated in FIGS. 12B and 12C, when the sample is placed closer to the floor (FIG. 12B), the objects on the floor are clearer when compared with that shown in FIG. 12C where the sample is moved away from the floor. As mentioned, the high level of optical haze of PMMA-based PTTW is due to the inherently high-haze characteristic of the underlying TW substrate (in this case, it is about 73.33% on average), it is believed that the PVA-based PTTW would have similar or comparable level of optical haze as the PMMA-based PTTW.

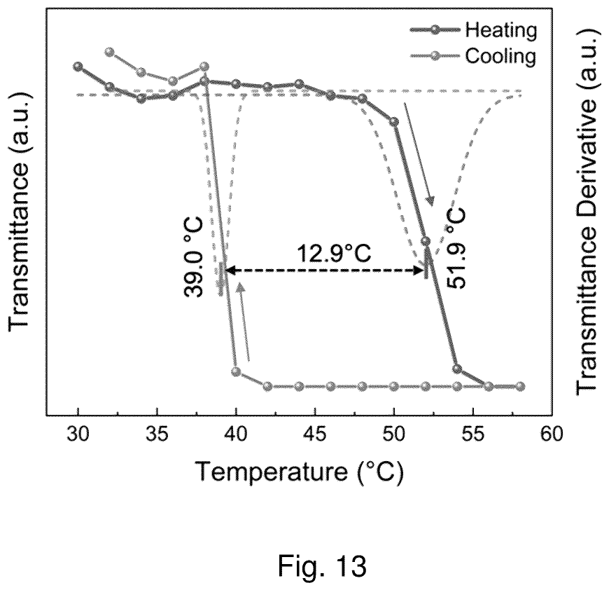

In addition to optical properties, it is also important to assess the transitional properties of PMMA-based PTTW which influence its practical operations in smart windows, including transition temperature Tₜᵣₐₙₛ and transition time tₜᵣₐₙₛ. FIG. 13 records the temperature-dependent optical transmittance of PMMA-based PTTW at 550 nm during both heating and cooling processes, along with the corresponding transmittance derivatives. The transmittance at 550 nm is chosen because the largest transmittance difference of hot- and cold-state PMMA-based PTTW is observed at this wavelength (FIG. 10A) which also corresponds to the peak CIE photopic luminous efficiency of the human eye. The transition temperature T_{trans,heating} and T_{trans,cooling} were calculated to be 52.8° C. and 36.3° C., respectively, as shown at the lowest points of the transmittance derivative curves (i.e., dash lines in FIG. 13), resulting in a thermochromic hysteresis width of 12.9° C.

Regarding the transition time tₜᵣₐₙₛ, it is measured that it requires about 170 s to transform to the colored hot state upon heating at the transition temperature while it only takes about 35 s to fade back to the bleached cold state, which is considered to be desired in real window applications. The transitional properties of PMMA-based PTTW (i.e., transition temperature T̅ₜᵣₐₙₛ=44.5° C., transition time (t̅ₜᵣₐₙₛ=102.5 s) are comparable to the glass-substrate perovskite thermochromic smart windows (i.e., transition temperature T̅ₜᵣₐₙₛ=40.5° C., transition time (t̅ₜᵣₐₙₛ=85.0 s), which means that PMMA-based PTTW can be deployed as regular thermochromic smart windows.

As for the PVA-based PTTW, it is measured that the transition temperature Tₜᵣₐₙₛ is less than 60° C. It is also measured that the PVA-based PTTW takes about 2 minutes to transform from the cold state to the hot state and about 3 minutes to transform back to the cold state (data not shown).

In sum, PMMA-based PTTW demonstrates excellent solar modulation ability as well as favourable transitional properties, manifesting its functionality of PMMA-based PTTW in smart window applications. On the other hand, it is noted that although the PVA-based PTTW does not include a protective layer such as a PMMA layer as the PMMA-based PTTW, the optical and transitional performance of the PVA-based PTTW is still good but not as good comparing to PMMA-based PTTW.

### Example 4

### Mechanical and Thermal Properties of PMMA-Based PTTW

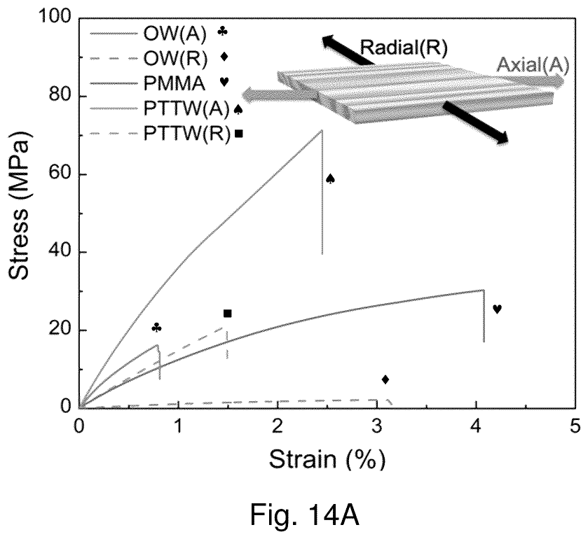

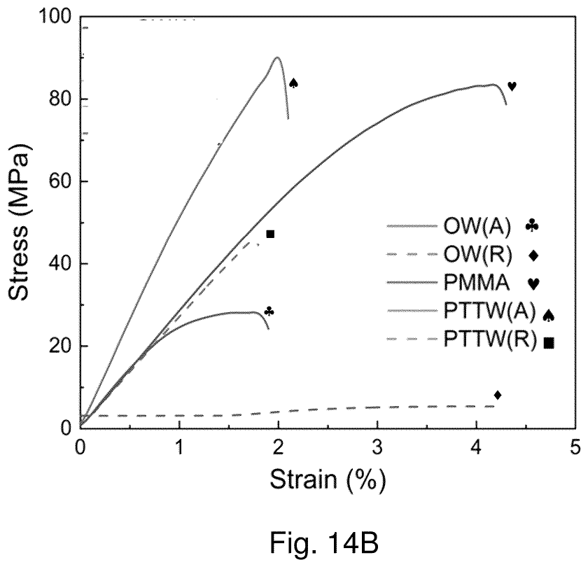

It is appreciated that robust mechanical strength and excellent thermal insulation are crucial to window applications in buildings. However, conventional glass windows are highly brittle (i.e., Young's modulus E=72 GPa) and thermally conductive (i.e., thermal conductivity K=1.4 W/(m·K)). The developed PMMA demonstrates enhanced mechanical properties credit to the synergetic reinforcement of the wood-PMMA composite brought by the above-shown strong bonding between the wood cell walls and PMMA. FIGS. 14A and 14B show the tensile and bending stress-strain curves of OW, neat PMMA and PMMA-based PTTW in both axial (A) and radial (R) directions.

PMMA-based PTTW with a thickness of about 1 mm features high tensile strength (σₜₑₙₛ) along the A direction of 71.4 MPa, which are remarkably higher than that of OW(A) (i.e., σₜₑₙₛ=16.2 MPa) and PMMA (i.e., σₜₑₙₛ=26.3 MPa). The σₜₑₙₛ of the R-direction PMMA-based PTTW is 20.7 MPa which is relatively lower than that of PMMA but still a lot higher than that of OW(A) and OW(R) (i.e., σₜₑₙₛ=1.18 MPa).

Notably, PMMA-based PTTW possesses larger Young's modulus (E) in both A and R directions (i.e., E=2.91 GPa and 1.41 GPa) than that of OW(i.e., E=2.05 GPa and 0.07 GPa) and PMMA (i.e., E=0.74 GPa), indicating its high toughness. Meanwhile, PMMA-based PTTW also exhibits high flexural strength (σ_{flex}) in the A direction of 93.1 MPa which is about 70% higher than that of OW(A) (i.e., σ_{flex}=28.1 MPa) and about 10% higher than that of PMMA (i.e., σ_{flex}=83.5 MPa). In the R direction, PMMA-based PTTW shows a σ_{flex} of 47.9 MPa which is also much higher than that of OW(R) (i.e., σ_{flex}=5.41 MPa).

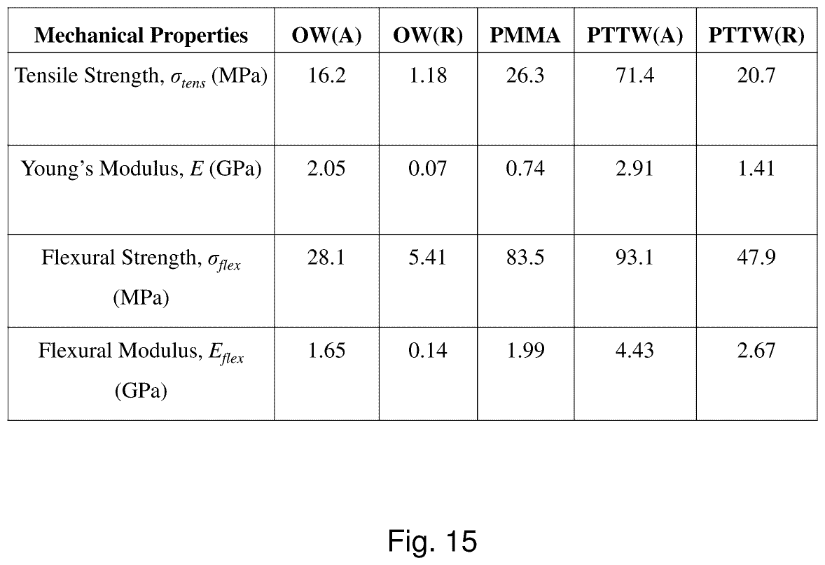

Last but not least, the flexural modulus (E_{flex}) of PMMA-based PTTW(A) and PMMA-based PTTW(R) are 4.43 GPa and 2.67 GPa, respectively, which are significantly larger than that of OW(A) (i.e., E_{flex}=1.65 GPa), OW(R) (i.e., E_{flex}=0.14 GPa), and PMMA (i.e., E_{flex}=1.99 GPa), manifesting its high stiffness. The mechanical properties of OW, PMMA-based PTTW, and PMMA are summarized in FIG. 15. In short, it is believed that the robust mechanical properties of PMMA-based PTTW, namely high toughness and stiffness, would help to mitigate the safety risks of windows.

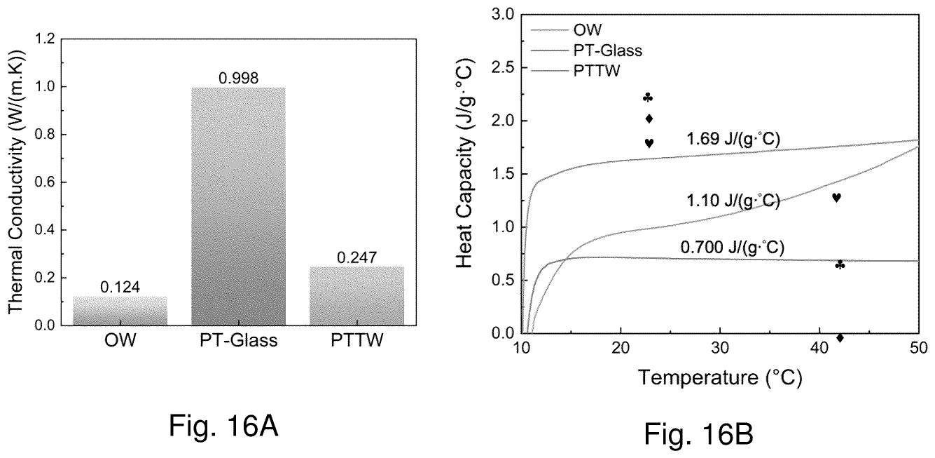

The thermal conductivity results of glass, original wood (OW), PMMA and transparent wood (TW) are shown in FIG. 16A. It is observed that conventional glass has the highest thermal conductivity of 1.1 W/(m·K), which is 10 times higher than that of OW(i.e., 0.124 W/(m·K)). After incorporating PMMA, the resultant PMMA-based PTTW demonstrates a thermal conductivity of 0.247 W/(m· K) which is still quite low as compared to glass. The low conductivity of PMMA-based PTTW can help reduce the energy loss through heat conduction, which is beneficial to the thermal management in built environment.

The heat capacity (C) curves of OW, PT-glass and PMMA-based PTTW within the normal operation temperature range of windows (i.e., from 10 to 50° C.) are illustrated in FIG. 16B. Notably, PT-glass exhibits a relatively flat curve when the temperature exceeds 10° C., with the C stabling at 0.70 J/(g·° C.) at 30° C. By contrast, OW demonstrates a noticeable upward trend in its C, with the C of 1.10 J/(g·° C.) at 30° C. Akin to OW, the C of PMMA-based PTTW also features an ascending profile but with a smaller slope because of the incorporation of PMMA, and yet it shows a C of 1.69 J/(g·° C.) at 30° C., which is the highest compared to PT-Glass and OW. It is believed that the higher C of PMMA-based PTTW would contribute to indoor temperature regulation of buildings, promoting thermal comfort and thermal energy storage.

### Example 5

### Stability Performance of PMMA-Based PTTW

It is believed that effective and stable modulation of solar radiation is crucial for ensuring dependable indoor thermal regulation using thermochromic smart windows. Although perovskite-based devices have demonstrated promising environmental resistance and performance stability, the hygroscopic nature of perovskite materials renders them vulnerable to moisture-induced degradation. Thus, a hydrophobic polymer, polymethyl methacrylate (PMMA) is incorporated as the top protective layer of the present PMMA-based perovskite thermochromic windows (PMMA-based PTTW) to enhance their water resistance.

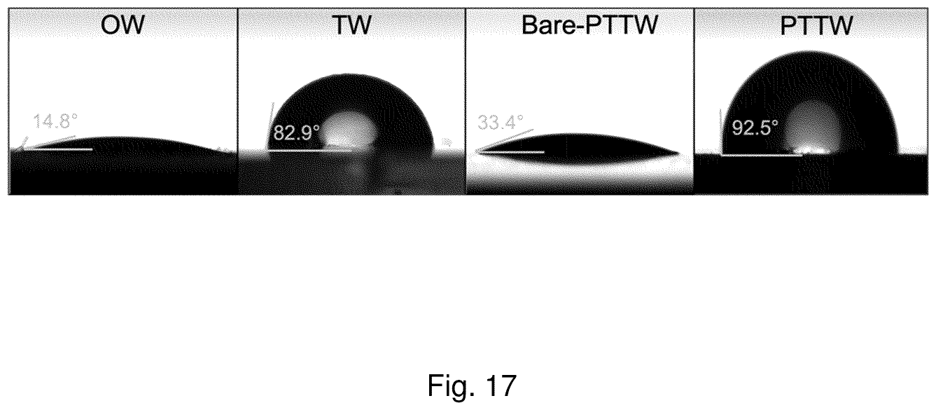

Water contact angle of different window types, including ordinary glass windows (OW), PMMA-based transparent wood (TW), bare PTTW (i.e., without PMMA coating), and PMMA-based PTTW are shown in FIG. 17. The contact angle of OW is relatively small (i.e., 14.8°), indicating high hydrophilicity, while TW exhibits a larger contact angle of 82.9° due to the presence of PMMA. However, as shown, the deposition of hydroscopic perovskite on the surface of bare-PTTW leads to the restoration of hydrophilicity with a contact angle of 33.4°. Finally, by coating PMMA on top of bare-PTTW, the contact angle of PMMA-based PTTW is enlarged to 92.5°, indicating its hydrophobicity.

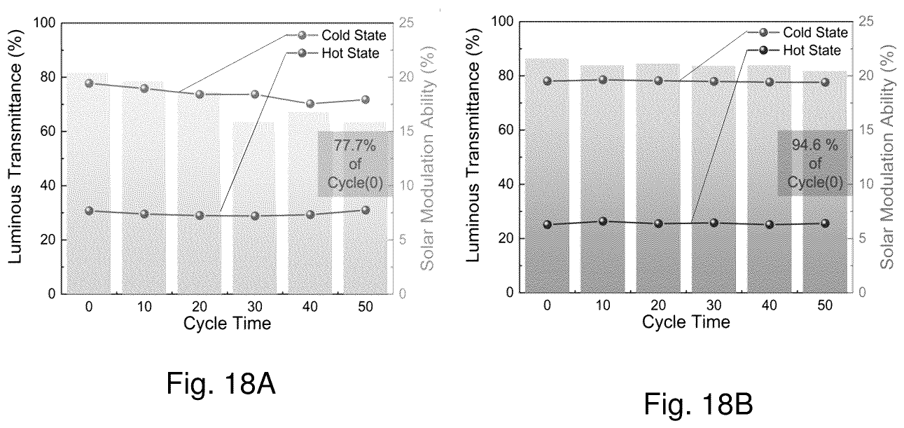

A cycle test was then conducted to examine the performance stability of bare-PTTW and PMMA-based PTTW, namely the capability of performing stable thermochromism over a total number of 50 heating-cooling cycles. During the cycle test, the tinting and bleaching transitions were consistently and steadily presented, and the hot- and cold-state solar transmittance in the visible range (i.e., 300-800 nm) were recorded every ten cycles. It can be clearly seen from FIG. 18A that there is a noticeable drop in the τ_{lum,cold} of bare-PTTW after 50 cycles while τ_{lum,hot} remains nearly unchanged. Consequently, the Δτₛₒₗ at cycle (50) is only 77% of that of cycle (0), meaning that the stability of bare-PTTW without the PMMA coating is unsatisfactory. By contrast, as reflected in FIG. 18B, there is no obvious change in the τ_{lum,cold} and τ_{lum,hot} of PMMA-based PTTW, so that the Δτₛₒₗ of PMMA-based PTTW at cycle (50) remains at 94.6% of that of cycle (0), proving the effectiveness of PMMA coating as the protective layer and demonstrating the promising performance stability of PMMA-based PTTW.

### Example 6

### Model-House Field Investigation of PMMA-Based PTTW

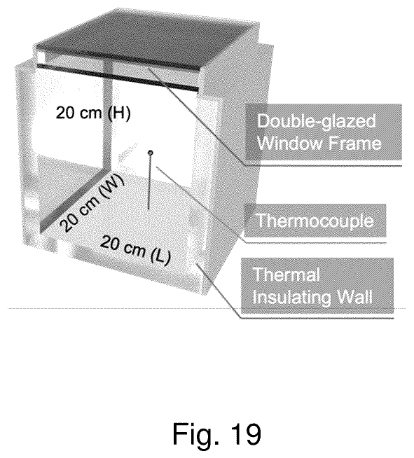

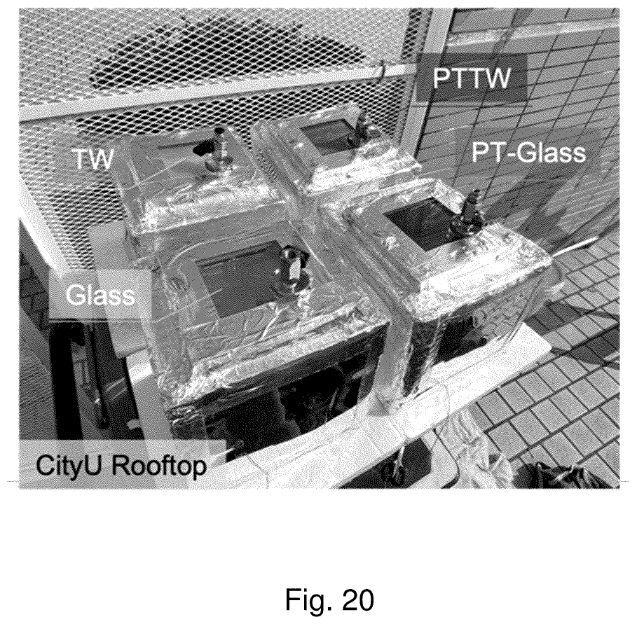

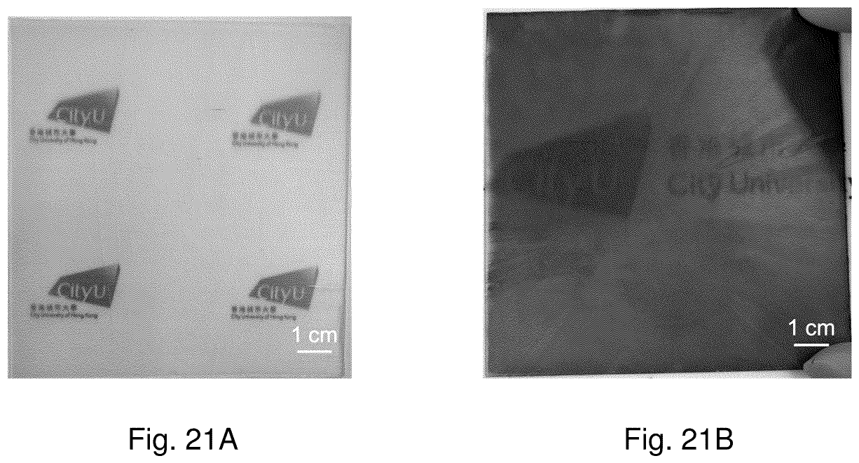

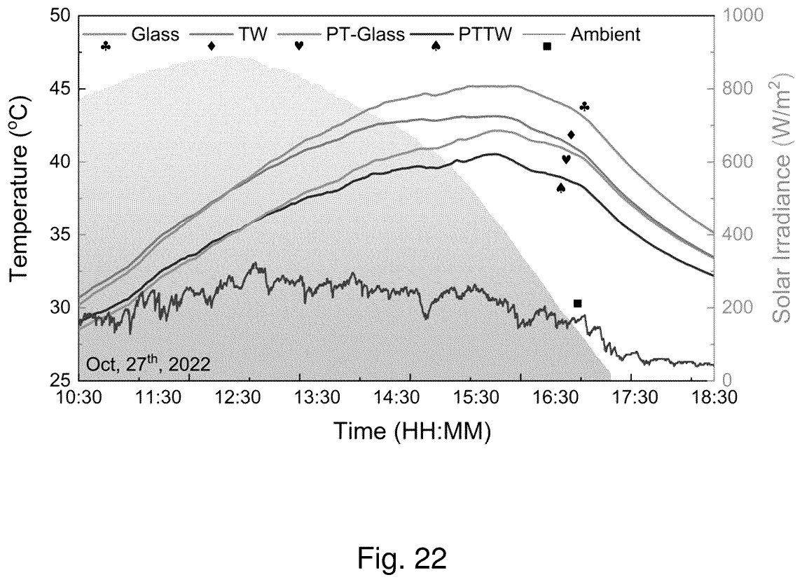

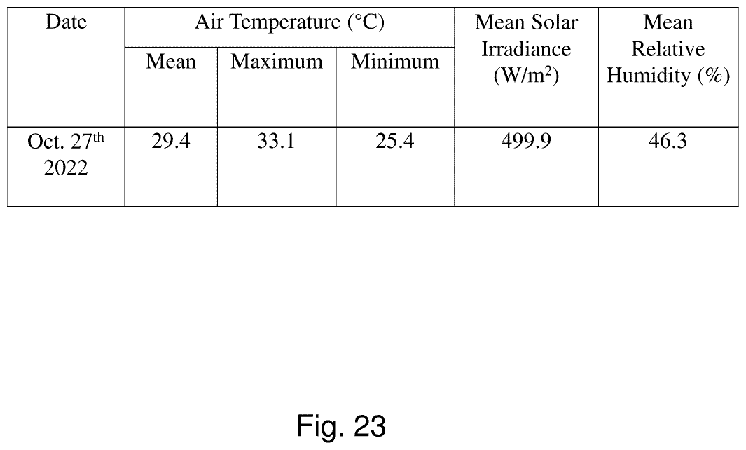

The applicational thermal-management performance of PMMA-based PTTW smart window was investigated by model-house field test in Hong Kong. The self-assembled model house used in the field test is illustrated in the schematic diagram of FIG. 19. The experimental setup is shown in FIG. 20 where four identical model houses were used, installed with the 10×10 cm² normal glass, PMMA-based TW (FIG. 21A), perovskite thermochromic glass (PT-glass), and PMMA-based PTTW (FIG. 21B), respectively. The indoor air temperature of the four model houses on an early-autumn sunny day (i.e., Oct. 27, 2022) in Hong Kong, as well as the real-time solar irradiance and ambient temperature monitored by the weather station are shown in FIG. 22 (the detailed meteorological data is shown in FIG. 23).

As shown, from 10:30 to 18:30, the model house with the normal glass always showed the highest indoor air temperature among the four houses with the peak temperature of 45.2° C. at around 16:00. The model house with PMMA-based TW had a similar indoor temperature as the glass one early in the day but started to drop lower than that of the Glass window due to the better thermal resistance of PMMA-based TW, and a maximum indoor temperature reduction of 2.57° C. was resulted. Meanwhile, the model houses with PT-Glass and PMMA-based PTTW experienced a delayed indoor temperature increase compared to those with Glass and PMMA-based TW, due to the thermochromic effect. Notably, the thermochromic windows achieved greater indoor temperature reductions of 3.87° C. for PT-Glass and 5.44° C. for PMMA-based PTTW. The superior indoor-temperature-reduction effect of PMMA-based PTTW over PT-Glass can be attributed to its overall lower solar transmittance and thermal conductivity. The model house field test results demonstrated the promising thermal-regulating performance of the PMMA-based PTTW smart window in real applications.

### Example 7

### Energy-Saving Potential of PMMA-Based PTTW

The promising thermal-regulating performance of the PMMA-based PTTW smart window has the potential to significantly reduce the cooling load of buildings, thereby enabling substantial energy savings in HVAC (heating, ventilation, and air conditioning) systems. To comprehensively assess the energy-saving potential of PMMA-based PTTW for use as smart window in real buildings, EnergyPlus energy-saving simulation was conducted.

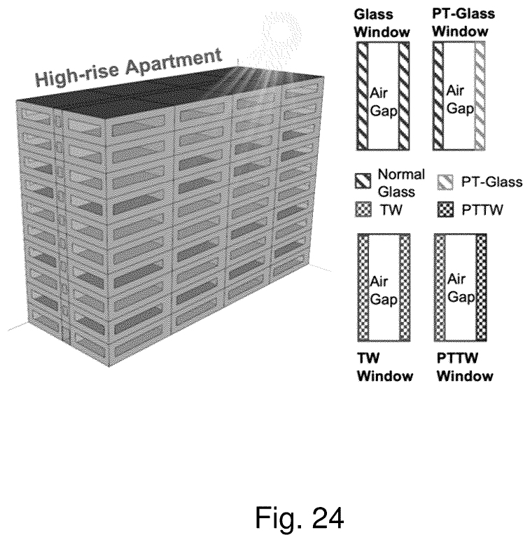

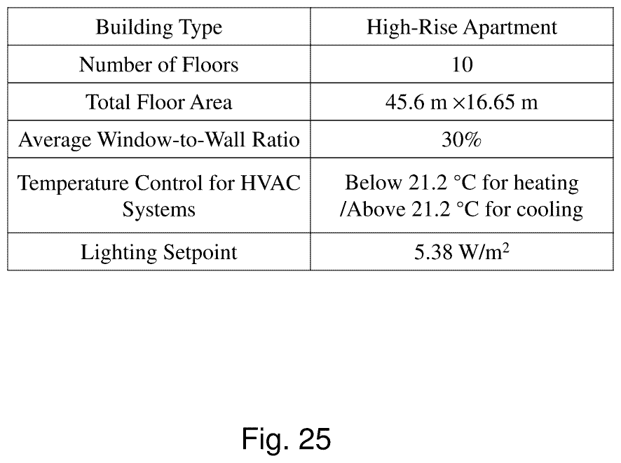

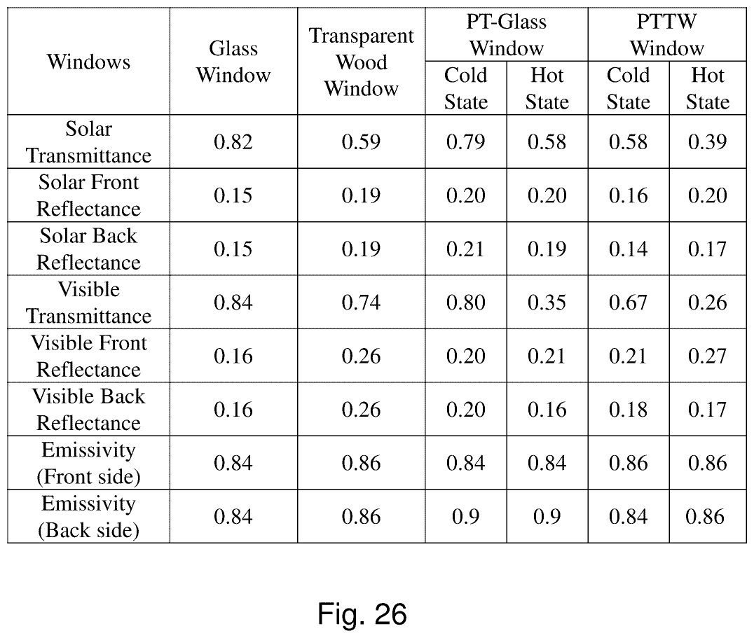

The employed high-rise apartment building model as well as the four investigated windows, namely the normal glass (Glass), PMMA-based transparent wood (PMMA-based TW), perovskite thermochromic glass (PT-Glass), and PMMA-based perovskite thermochromic transparent wood (PMMA-based PTTW) are schematically shown in FIG. 24. The detailed building constructional information and window optical & thermal information are summarized in FIGS. 25 and 26, respectively. Glass window is regarded as the benchmark and the other three windows are expected to generate energy-saving effects due to the solar blocking/regulation and thermal insulation.

As shown in FIG. 25, PMMA-based TW window has a lower solar transmittance and visible transmittance as compared with Glass window, suggesting an overall lower light transmittance of the PMMA-based TW window. In addition, it is reported that PMMA-based TW window has a lower thermal conductivity (about 0.23 W/(m·K)) than glass window (about 1.0 to about 1.4 W/(m·K)). Thus, taken together, it is believed that the PMMA-based TW window would generate energy-saving effects over glass window.

Both the PT-Glass window and PMMA-based PTTW window possess thermochromism-driven solar modulation ability. Both shows changes in their solar and visible transmittance between cold and hot states (FIG. 25). In particular, it is believed that PMMA-based PTTW window embodied the best of both the PMMA-based TW and PT-Glass windows' strengths over the Glass window. That is, the solar modulation ability of PT-Glass, lower solar transmittance and visible transmittance of PMMA-based TW window, and lower thermal conductivity (about 0.24 W/(m·K), FIG. 16A).

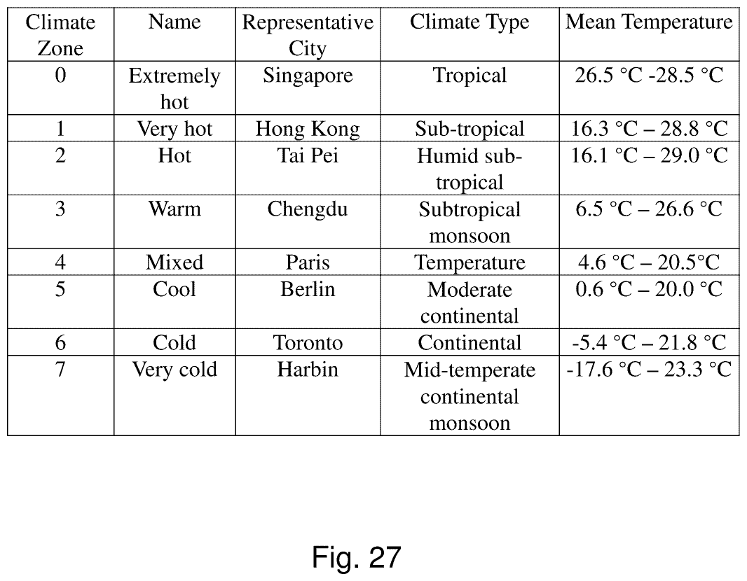

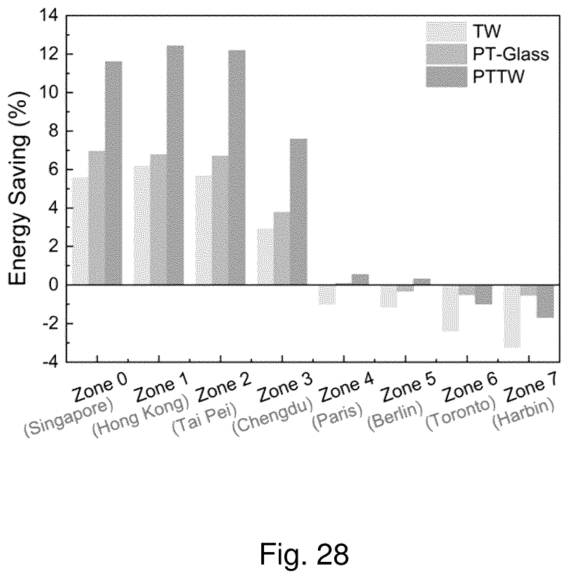

Considering the wide applicability of the PMMA-based PTTW smart window under different climate conditions, the simulations were executed in 8 climate zones according to ASHARE Standard (i.e., Zone 0 to Zone 7), and the climate zone information is summarized in FIG. 27. FIG. 28 shows the HVAC energy saving percentages of the PMMA-based TW, PT-Glass and PMMA-based PTTW windows compared to Glass window in 8 zones. It is apparent that PMMA-based PTTW-equipped building demonstrates significant energy saving effects in Zone 0-3, with the corresponding energy savings of 11.6%, 12.4%, 12.2% and 7.6%, respectively, outperforming PMMA-based TW (i.e., energy savings of 5.59%, 6.21%, 5.7% and 2.91%) and PT-Glass (i.e., 6.95%, 6.78%, 6.7% and 3.78%). The significant energy-saving effects in these four zones are mainly due to the reduction in cooling load resulted from the solar regulation and heat insulation.

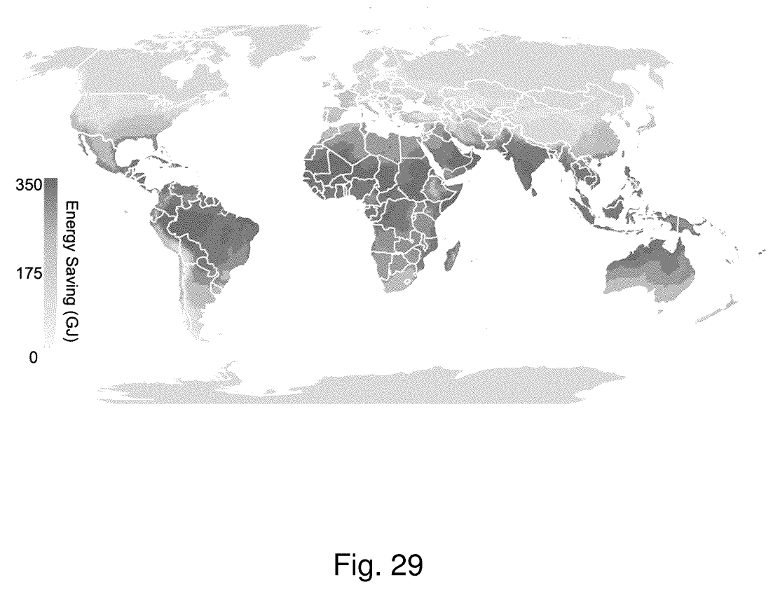

Conversely, in zone 4-7, the energy saving effects of these three windows are not obvious (i.e., less than 1%) and even results slight negative effect since the relatively low transmittance would affect the solar heat gain through windows and thus elevate the building heating demand in winter. The global energy effect of PMMA-based PTTW window is further visualized in the world map as shown in FIG. 29, where the deeply shaded areas reflect the notable energy-saving effect. It can be concluded that PMMA-based PTTW window is more applicable and high-performance in the tropical and subtropical regions which has high population density and projected population & economic growth.

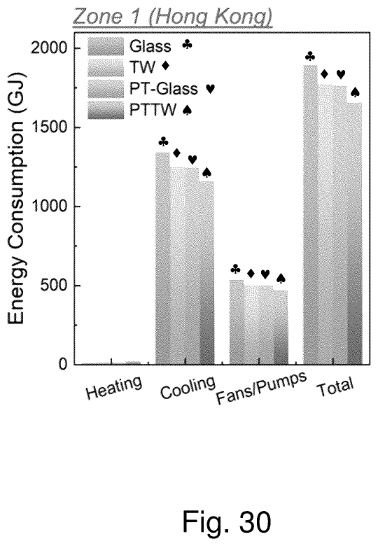

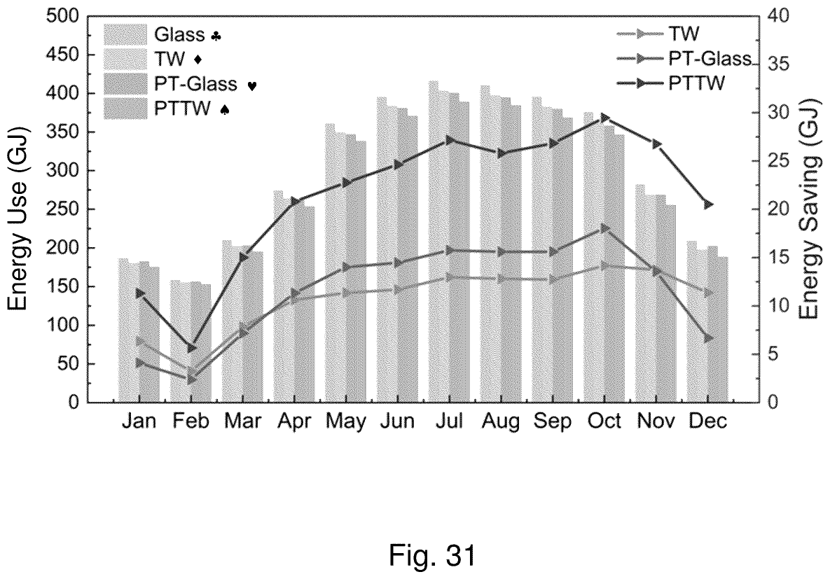

Next, the energy-saving performance was studied in a more detailed and dynamic manner focused in Hong Kong where the highest energy-saving percentage is demonstrated. Based on the results presented in FIG. 30, it is evident that the cooling system, along with its auxiliary components such as fans and pumps, dominate the total HVAC energy consumption and there is nearly no heating energy use, resulting in the overall hump-shaped monthly energy consumption trend, with peak energy consumption being observed during summer months and declining during winter months, as illustrated in FIG. 31. As for energy savings, the energy-saving performance of the PMMA-based PTTW is superior to that of the PMMA-based TW and PT-Glass window systems throughout most of the year, with the exception of February, wherein no energy saving is observed for all three window systems due to the absence of cooling demands during this month. The energy savings of the PMMA-based PTTW system steadily increase from March and reach their highest level in October.

The invention has been given by way of example only, and various other modifications of and/or alterations to the described embodiment may be made by persons skilled in the art without departing from the scope of the invention as specified in the appended claims.

1. A composite material comprising
an optically transparent substrate;
a thermochromic layer provided on the substrate; and
a protective layer provided on the thermochromic layer;
wherein the optically transparent substrate comprises a wood-based material impregnated with a first polymer.

2. The composite material as claimed in claim 1, wherein the thermochromic layer comprises a halide perovskite-based compound having a chemical composition of A, B, and X, with A being one or more of a monovalent organic or metal cation, B being a bivalent metal cation, and X being one or more of a halide.

3. The composite material as claimed in claim 2, wherein the halide perovskite-based compound has a general formula of (CH₃NH₃)₄PbI_{6-x-y}BrₓCl_{y}·2H₂O, with x and y each being 0 or a positive integer, and x+y≤6.

4. The composite material as claimed in claim 3, wherein the halide perovskite-based compound is (CH₃NH₃)₄PbI₅Br₁·2H₂O.

5. The composite material as claimed in claim 1, wherein the thermochromic layer has a thickness of about 1.1 μm.

6. The composite material as claimed in claim 1, wherein the protective layer comprises a second polymer selected from a group consisting of poly(methyl methacrylate), octadecyltrichorosilane, hexadecyltrimethoxysilane, and a combination thereof.

7. The composite material as claimed in claim 1, wherein the protective layer forms a hydrophobic surface.

8. The composite material as claimed in claim 1, wherein the wood-based material comprises a plurality of lignin-modified wood fibers that are decolorized, aligned to form an interconnected network structure and being infiltrated with the first polymer.

9. The composite material as claimed in claim 8, wherein the wood-based material comprises any one of balsa wood, oak, beech, birth, ash and basswood.

10. The composite material as claimed in claim 1, wherein the first polymer is selected from a group consisting of epoxy resin, poly(methyl methacrylate), polyvinylpyrrolidone, poly(vinyl alcohol), polydimethylsiloxane, poly(acrylic acid), poly(acrylamide), poly(aniline), poly(ethylene oxide), poly(N-acryloxysuccinimide), poly(N-isopropylacrylamide), poly(N-isopropylmethacrylamide), poly(N-vinylcaprolactam), poly(N-vinylpyrrolidone), poly(methacrylic acid), poly(styrene sulfonic acid), polyurethane, poly(propylene oxide), and a combination thereof.

11. The composite material as claimed in claim 1, wherein the wood-based material comprises lignin-modified balsa wood, the first and second polymers are poly(methyl methacrylate) and the halide perovskite-based compound has a general formula of (CH₃NH₃)₄PbI_{6-x-y}BrₓCl_{y}·2H₂O, with x and y each being 0 or a positive integer, and x+y≤6.

12. The composite material as claimed in claim 2, wherein the composite material has a luminous transmittance of at least 21% when ambient temperature is at or above a first temperature and at least 78% when ambient temperature is at or below a second temperature.

13. The composite material as claimed in claim 12, wherein the first temperature is at least 52° C. to 53° C. or above.

14. The composite material as claimed in claim 13, wherein the second temperature is about 36° C. to 37° C. or less.

15. The composite material as claimed in claim 12, wherein solar modulation ability of the composite material at 50 cycles is maintained at at least 94% of the solar modulation ability at 0 cycle.

16. The composite material as claimed in claim 15, wherein the solar modulation ability is above 21%.

17. The composite material as claimed in claim 2, wherein the composite material has an optical haze of about 90% or above.

18. The composite material as claimed in claim 7, wherein the composite material has a tensile strength at about 56 MPa, a flexural strength of about 93 MPa and a thermal conductivity at at least 0.24 W/(m·K).

19. A composite material comprising
an optically transparent substrate;
a thermochromic layer provided on the substrate; and
a protective layer provided on the thermochromic layer;
wherein the optically transparent substrate comprises a wood-based material impregnated with a first polymer; and wherein the wood-based material comprises any one of balsa wood, oak, beech, birth, ash and basswood.

20. A method for preparing the composite material as claimed in claim 1, comprising the steps of:
a) removing chromophores of lignin in a wood material to form a lignin-modified wood-based material;
b) impregnating a pre-polymerized first polymer into the lignin-modified wood-based material;
c) polymerizing the first polymer which is impregnated in the lignin-modified wood-based material;
d) spin-coating a thermochromic layer of halide perovskite-based compound on to the lignin-modified wood-based material obtained in step c); and
e) spin-coating a second polymer onto the thermochromic layer.

21. The method as claimed in claim 20, wherein the lignin-modified wood-based material in step c) is treated by a plasma cleaner.

22. The method as claimed in claim 20, wherein the lignin-modified wood-based material in step d) is thermally annealed at about 90° C.

23. The method as claimed in claim 20, wherein step e) further comprises the step of e1) thermally annealing the second polymer which is spin-coated on the thermochromic layer.

24. The method as claimed in claim 20, wherein step a) is UV-assisted bleaching by illuminating the wood material with UV for about 20 mins.

25. The method as claimed in claim 24, wherein step a) includes brushing 30 wt % of H₂O₂ oxidant and 10 wt % of NaOH onto the wood material before illuminating the wood material with UV.

26. The method as claimed in claim 20, wherein the first polymer is poly(methyl methacrylate) which is pre-polymerized at 75° C. for 15 min in a hot-water bath with 0.5 wt % of 2,2′-azobis (2-methylpropionitrile) (AIBN) (98%) as initiator.

27. The method as claimed in claim 20, wherein the halide perovskite-based compound comprises (CH₃NH₃)₄PbI₅Br₁·2H₂O.

28. The method as claimed in claim 27, wherein (CH₃NH₃)₄PbI₅Br₁·2H₂O is formed from a (CH₃NH₃)₄PbI₅Br₁·2H₂O halide hybrid perovskite precursor by dissolving methylammonium iodine (MAI), methylammonium bromide (MABr) and lead iodine (PbI₂) with a molar ratio of 3:1:1 in DMF until it forms a homogeneous and transparent solution.

29. The method as claimed in claim 20, wherein the second polymer is poly(methyl methacrylate) which was dissolved in chlorobenzene (CB) with a ratio of 0.1 g:1000 μL.
